(19) United States
(12) Patent Application Publication
(10) Pub. No.: US 2012/0062728 A1
(43) Pub. Date: Mar. 15, 2012

(54) SURFACE INSPECTING DEVICE

(75) Inventors: Satoshi Oikawa, Tochigi (JP); Satoshi Nojo, Tochigi (JP)

(73) Assignee: HONDA MOTOR CO., LTD., MINATO-KU, TOKYO (JP)

(21) Appl. No.: 13/319,781

(22) PCT Filed: Feb. 1, 2010
(86) PCT No.: PCT/JP2010/000574

§ 371 Date: Nov. 10, 2011

(30) Foreign Application Priority Data
May 21, 2009 (JP) 2009-123144
May 26, 2009 (JP) 2009-126128
May 29, 2009 (JP) 2009-131335

(51) Int. Cl. H04N 7/18; G06K 9/00

(52) U.S. Cl. 348/128; 382/108; 348/E07.085

(57) ABSTRACT

The presence or absence of a deep machining work trace is detected, and the position and size of the machining work trace are allowed to be estimated, whereby an inspection time can be shortened.

A surface inspecting device 9 for inspecting a polished inner surface 3A of a bore 3 formed in a cylinder block 5 by a boring work on the basis of a digital brightness image 70 of the inner surface 3A of the bore 3 is provided with an estimation image generator 55 for generating and parallel arranging one-dimensional power spectral images 71 in a direction perpendicular to the direction of cutting work traces P along the direction of the cutting work traces P on the basis of the digital brightness image 70 to generate an estimation image 73, and an estimator 57 for estimating the presence or absence of polishing residue Q on the inner surface 3A of the bore 3 on the basis of pixel values of respective pixels of the estimation image 73.

### TECHNICAL FIELD

The present invention relates to a surface inspecting device for inspecting the surface of a machined workpiece.

### BACKGROUND ART

In a process of manufacturing vehicles, a cutting work is executed on a cylinder block of an engine to form a bore in the cylinder block, and then a cylinder head, a crank case, etc. are assembled to the cylinder block to fabricate an engine. The cutting work of the bore is performed by a boring work of advancing and retreating a boring bite to and from the cylinder block while rotating the boring bite, thereby forming a bore. A spiral cutting work trace occurs on the inner surface of the bore because the boring work is used for the bore cutting work, and thus the cutting work trace is available as a passage (oil pit) for engine oil.

The inner surface of the bore serves as a sliding face of a piston, and thus it is necessary that the sliding face is kept to have proper surface roughness and proper surface property so that the sliding resistance is suppressed to make the engine exercise a desired performance. Therefore, after the boring work, a honing work is executed to polish-finishing the inner surface of the bore to the extent that an oil pit remains. After the honing work, a smoothness state of the inner surface of the bore is inspected to check a polishing residue which causes the sliding resistance.

This inspection is executed according to a procedure of inserting an optical unit into the bore, picking up a reflection image of a laser beam emitted from the optical unit through the optical unit, generating a digital image of the inner surface of the bore, subjecting this digital image to two-dimensional power spectral processing to generate a two-dimensional power spectral image and estimating the smoothness state on the basis of the two-dimensional power spectral image (for example, see Patent Document 1).

### PRIOR ART

### Patent Document

Patent Document 1: JP-A-2004-132900

### SUMMARY OF THE INVENTION

### Problem to be Solved by the Invention

However, with respect to the inspection using the power spectral image, it is possible to determine the overall roughness of the inner surface of the bore, but it is impossible to know the viewable range and size of a polishing residue on the basis of the power spectral image because the power spectral image concerned has no space information. Accordingly, in order to specify a polishing residue site, a worker is required to visually check a digital image obtained by imaging a bore, find out a site estimated as a polishing residue, and take the size and shape of the site into consideration to make a final determination as to whether the site is an oil pit or a polishing residue.

Furthermore, with respect to two-dimensional power spectral image analysis, frequency components of all directions of 360° are subjected to integrated and comprehensive analysis as a plane, and thus information on some target direction, position information on a line of the target direction concerned, etc. are missing. That is, the two-dimensional power spectral image analysis is suitable to perform an integrated estimation on the smoothness state of the overall plane, but it is impossible to obtain position information and size information of a specific polishing residue, a cutting work trace, etc. as described above. Furthermore, since the analysis is performed on all the directions of 360°, the amount of information to be processed is large, and thus much time is taken to perform the processing.

As described above, the prior art can know only the degree of overall roughness of the inner surface of the bore, but cannot know the range and size of the polishing residue. Therefore, there is such a problem that the worker is finally required to find out the site of the polishing residue and visually check and determine it and also much time is required to perform an inspection.

The present invention has been implemented in view of the foregoing situation, and has an object to a surface inspecting device that can detect the presence or absence of a depth machining work trace on a machined surface of a workpiece and also estimate the position and size of the depth machining work trace to thereby shorten an inspection time.

### Means of Solving the Problem

In order to attain the above object, a surface inspecting device for inspecting a machined surface of a workpiece on the basis of a digital image of the surface of the workpiece characterized by comprising: estimation image generating means that generates one-dimensional power spectral images in a direction perpendicular to a direction of a machining work on the basis of the digital image and arranging the one-dimensional power spectral images in parallel along the direction of the machining work to generate an estimation image; and estimating means that estimates the surface on the basis of pixel values of respective pixels of the estimation image.

According to the present invention, a one-dimensional power spectral image in which the direction perpendicular to the direction of the machining work is set to the one-dimensional direction is generated. In this one-dimensional power spectral image, the pixel values of the site corresponding to the pitch of the machining work traces have values corresponding to the difference in brightness of reflection light at the machining work traces. When the difference in brightness is large, the machining work trace is frequently deep, and thus the depth of the machining work trace can be determined on the basis of the pixel value. The pixel value represents the intensity of the signal of a brightness image, that is, represents intensiveness of amplitude of brightness variation of reflection light, and the magnitude of the difference in brightness is reflected to the pixel value.

In the estimation image in which one-dimensional spectral images described above are arranged in parallel, machining work traces which periodically occur on the surface of a workpiece and contain not only deep machining work traces, but also shallow machining work traces are reflected to the pixel values, and thus these machining work traces can be easily detected together with the depths thereof. Furthermore, the one-dimensional power spectral images are arranged in parallel to generate the estimation image, whereby the parallel-arrangement direction is coincident with the machining work direction and thus the position of the machining work trace can be specified from the estimation image. Furthermore, the size of the machining work trace (extending length) can be estimated on the basis of the spread of the pixel values representing the machining work traces in the parallel-arrangement direction. Therefore, a worker can detect the presence or absence of a deep machining work trace or shallow machining work without visually checking them, and thus the worker can easily determine the site and size thereof. When the worker actually checks with his/her eyes, the worker can grasp the site of the machining work trace in advance, and thus he/she can easily find out the machining work trace. Therefore, an inspection time can be shortened.

In order to attain the above object, according to the present invention, a surface inspecting device for inspecting a polished inner surface of a bore formed in a cylinder block by a cutting work on the basis of a digital image of the inner surface of the bore is characterized by comprising: estimation image generating means that generates one-dimensional power spectral images in a direction perpendicular to a direction of the cutting work on the basis of the digital image and arranging the one-dimensional power spectral images in parallel along the direction of the cutting work to generate an estimation image; and estimating means that estimates polishing residue on the inner surface of the bore on the basis of pixel values of respective pixels of the estimation image.

According to this invention, a one-dimensional power spectral image in which the direction perpendicular to the direction of the machining work is set to one-dimensional direction is generated. In this one-dimensional power spectral image, the pixel values of the site corresponding to the pitch of the cutting work traces has values corresponding to the difference in brightness of reflection light at the cutting work traces, that is, the depth of the cutting work traces . Therefore, an estimation image extracting only frequency components of cutting work traces necessary to estimate polishing residue of the bore is obtained, and thus the polishing residue can be efficiently estimated.

Furthermore, an estimation image is generated by arranging one-dimensional power spectral images in parallel, so that the parallel-arrangement direction is coincident with the cutting work direction and thus the position of the polishing residue can be specified from the estimation image. Furthermore, the size (extending length) of the polishing residue can be estimated on the basis of the spread of the pixel values representing the polishing residue in the parallel-arrangement direction. Therefore, a worker can detect the presence or absence of polishing residue without visually checking them, and thus the worker can easily determine the site and size thereof. When the worker actually checks with his/her eyes, the worker can grasp the site of the polishing residue in advance, and thus he/she can easily find out the polishing residue. Therefore, an inspection time can be shortened.

Still furthermore, in order to attain the above object, a surface inspecting device for inspecting a machined surface of a workpiece on the basis of a digital image of the surface of the workpiece is characterized by comprising: estimation image generating means that generates an image obtained by successively generating and parallel arranging one-dimensional power spectral images along a predetermined direction on the basis of the digital image to generate an image, rotates the predetermined direction with respect to the digital image every predetermined angle to generate the image at each rotational angle, and selects an image containing a largest number of spectral signals as an estimation image from respective images; and estimating means that estimates the surface on the basis of pixel values of respective pixels of the estimation image selected by the estimation image generating means.

According to this invention, an image in which one-dimensional power spectral images are successively generated and arranged in parallel along a predetermined direction is generated while the predetermined direction is rotated with respect to the digital image by every predetermined angle, and an image having a largest number of spectral signals is selected as the estimation image from the respective images. Therefore, the image comprising the one-dimensional power spectral images perpendicular to the machining work direction can be selected as the estimation image without obtaining the machining work direction in advance. Furthermore, the machining work direction can be specified.

Furthermore, the presence or absence of not only a deep machining work trace, but also a shallow machining work trace can be detected on the basis of the pixel values of the estimation image, and also the position of the machining work trace can be specified. Still furthermore, the size (extending length) of the machining work trace can be determined on the basis of the spread of the pixel values representing the machining work trace in the parallel-arrangement direction. Accordingly, the presence or absence of not only the deep machining work trace, but also the shallow machining work trace can be detected without worker's visual check, and also the site and size thereof can be determined. When the worker actually checks with his/her eyes, he/she can grasp the site of the polishing residue in advance, and thus can easily find it, so that the inspection time can be shortened.

Here, in this invention, pixels having pixel values exceeding a predetermined pixel value in the estimation image may be color-coded together with the respective pixels of the one-dimensional power spectral image containing the pixels concerned, thereby clarifying a range in which a deep machining work trace or a shallow machining work trace exists.

In order to attain the above object, a surface inspecting device for scanning a surface of a workpiece with a sensor head for irradiating the surface with a laser beam, generating a digital image of the surface on the basis of reflection light of the laser beam and subjecting the digital image to image processing for detecting a defect on the surface, thereby inspecting the surface is characterized by comprising: an eddy current inspecting sensor that scans the surface; and inspecting range determining means that specifies a defect site of the workpiece on the basis of an output of the eddy current inspecting sensor and determines an inspecting range containing the defect site, wherein the inspecting range is subjected to the image processing to detect a defect on the surface.

According to this invention, the defect site on the surface of the workpiece is detected by the eddy current inspecting sensor, and thus the defect site can be detected without being affected by foreign material such as water droplets, dust or the like on the surface. Furthermore, although the size of a defect and whether a defect is a surface defect or an internal defect such as a cavity or the like cannot be determined on the basis of the output of the eddy current inspecting sensor, the image processing is executed on the range containing the defect site in the digital image, and thus the size, etc. of the defect can be determined. Accordingly, the defect can be detected without being affected by the presence or absence of foreign material on the surface, and also the range to be subjected to the image processing is narrowed down, so that the time required for the inspection can be shortened and the size, etc. of the defect can be determined.

In order to attain the above object, a surface inspecting device for scanning a polished inner surface of a bore formed in a cylinder block by a cutting work with a sensor head for applying a laser beam, generating a digital image of the surface on the basis of reflection light of the laser beam and subjecting the digital image to image processing for detecting a defect on the inner surface, thereby inspecting the inner surface is characterized by comprising: an eddy current inspecting sensor that scans the inner surface; and image processing range determining means that specifies a defect site on the basis of an output of the eddy current inspecting sensor and determines an image processing range containing the defect site, wherein the image processing range is subjected to the image processing to detect a defect on the inner surface.

According to this invention, the defect site of the inner surface of the bore is detected by the eddy current inspecting sensor. Therefore, the defect site can be detected without being affected by foreign material such as water droplet, dust or the like on the inner surface of the bore. At this time, the accurate size of the defect and whether the defect is a surface defect or an internal defect such as a cavity or the like cannot be determined on the basis of the output of the eddy current inspecting sensor. However, the image processing is executed on the image processing range containing the defect site in the digital image, and thus the dent, the polishing residue, the oil pit, etc. can be discriminated by determining the size, etc. of the defect. Accordingly, the defect can be detected without being affected by the presence or absence of the foreign material on the surface, and the range to be subjected to the image processing is narrowed down to the image processing range containing the defect site, whereby the time required for the inspection can be shortened, and the dent, the polishing residue, the oil pit, etc. can be identified.

According to this invention, the eddy current inspecting sensor may be provided to the sensor head.

According to this construction, the digital image of the surface of the workpiece and the defect detection of the eddy current inspecting sensor may be performed by one scanning operation.

In order to attain the above object, a surface inspecting device is characterized by comprising: a sensor head for scanning an inner surface of a bore formed in a cylinder block by a cutting work while irradiating the inner surface with light, and outputting a detection signal corresponding to a light amount of reflection light of the light; and detecting means that detects a flaw on the inner surface on the basis of the detection signal, wherein the detecting means changes a determining threshold value for the detection signal for determining the flaw in accordance with an intersecting angle between a scan direction at a scan position of the sensor head and a direction of the cutting work.

According to this invention, the determining threshold value for determining a flaw is changed in accordance with the intersection angle between the scan direction of the sensor head to the inner surface of the bore and the direction of the cutting work. Therefore, the flaw detection precision of the inner surface of the bore can be enhanced without being affected by the scan direction and the cutting work direction at the scan direction.

In order to attain the above object, the detecting means may has noise compressing means that lowers a voltage value of a voltage range corresponding to noise with respect to the detection signal to compress the noise, and the noise compressing means may change the voltage range in accordance with the intersection angle between the scan direction at the scan position of the sensor head and the direction of the cutting work.

According to this invention, the predetermined voltage range for noise compression is changed in accordance with the intersection angle between the scan direction of the sensor head to the inner surface of the bore and the cutting work direction. Therefore, S/N of the detection signal output from the sensor head can be enhanced without being affected by the scan direction and the cutting work direction at the scan direction.

The above invention may be provided with storage means that stores the determining threshold value corresponding to the intersection angle between the scan direction at the scan position of the sensor head and the direction of the cutting work in association with the scan position; and D/A conversion means that outputs an analog signal of a voltage value representing the determining threshold value, wherein the detecting means has a comparator for comparing the analog signal output from the D/A conversion means with the detection signal.

According to this invention, the analog signal of the voltage value representing the determining threshold value is directly input to the comparator. Therefore, there is no delay time when the determining threshold value is changed, and thus high-speed surface inspection can be implemented.

This application contains the whole contents described in Japanese Patent Applications (Japanese Patent Application No. 2009-126128, Japanese Patent Application No. 2009-123144 and Japanese Patent Application No. 2009-131335) on the basis of which priorities are claimed.

### EFFECT OF THE INVENTION

According to this invention, there is obtained the estimation image containing one-dimensional power spectral images in which the pixel values of the site corresponding to the pitch of the machining work traces have values corresponding to the difference in brightness of reflection light at the machining work traces and which are arranged in conformity with the machining work direction. The presence or absence of not only the deep machining work traces, but also shallow machining work traces can be detected on the basis of the estimation image, and furthermore the positions and sizes thereof can be determined. Accordingly, the worker is not required to check with his/her eyes, and thus the inspection time can be shortened.

Furthermore, when the worker inspects the inner surface of the bore of the cylinder block, the polishing residue of the cutting work trace can be efficiently determined. Furthermore, the position and size thereof can be determined.

Still furthermore, an image in which one-dimensional power spectral images are successively and parallel arranged along a predetermined direction is successively generated while the predetermined direction is rotated by every predetermined angle with respect to the digital image, and an image containing a largest number of spectral signals is selected as an estimation image from the respective images. Accordingly, an image comprising one-dimensional power spectral images perpendicular to the direction of the machining work can be selected as an estimation image without obtaining the direction of the machining work.

Furthermore, the pixels whose pixel values are over the predetermined pixel value are color-coded together with the respective pixels of the one-dimensional power spectral image containing the pixels concerned, thereby clarifying the range in which deep machining work traces or shallow machining work traces exist.

Still furthermore, according to the present invention, the defect of the workpiece can be detected by the eddy current inspecting sensor without being affected by foreign material such as water droplet, dust or the like which adheres to the surface of the workpiece. Furthermore, the image processing can be executed while the range to be subjected to the image processing is limited to the image processing range. Therefore, the time required for the inspection can be shortened.

Furthermore, when the inner surface of the bore of the cylinder block is set as an inspection target, oil pits and harmful defects such as a dent, polishing residue, etc. can be efficiently identified, and thus a defective bore can be selected.

Furthermore, the eddy current inspecting sensor is provided to the sensor head, and thus the digital image of the surface of the workpiece and the defect detection of the eddy current inspecting sensor can be performed by only one scanning operation.

According to this invention, the determining threshold value for determining a flaw is changed in accordance with the intersection angle between the scan direction of the sensor head to the inner surface of the bore and the cutting work direction. Therefore, the flaw on the inner surface of the bore can be detected without being affected by the scan direction and the cutting work direction at the scan direction.

Furthermore, the noise compressing means for lowering the voltage value of the voltage range corresponding to the noise to compress the noise is provided, and the voltage range is changed in accordance with the intersection angle between the scan direction of the sensor head to the inner surface of the bore and the cutting work direction, whereby S/N of the detection signal can be enhanced without being affected by the scan direction and the cutting work direction at the scan position.

Still furthermore, the analog signal of the voltage value corresponding to the determining threshold voltage is directly input to the comparator for comparison with the detection signal, whereby the high-speed inspection can be implemented without any time delay when the determining threshold value is changed.

### BRIEF DESCRIPTION OF THE DRAWINGS

FIG. 1 is a diagram showing the constructions of a bore inner surface inspecting system having a surface inspecting device according to a first embodiment of the present invention and a cylinder block having a bore formed as an inspection target therein.

FIG. 2 is a diagram showing an image generated through bore inner surface inspection along inspection flow.

FIG. 3 is a diagram showing a process of generating a one-dimensional power spectral image by an estimation image generator.

FIG. 4 is a diagram showing the relationship between a one-dimensional digital brightness image and a one-dimensional power spectrum.

FIG. 5 is a flowchart showing bore inner surface inspecting processing.

FIG. 6 is a diagram showing the construction of a surface inspecting system according to a modification of the present invention together with a workpiece as an inspection target.

FIG. 7 is a diagram showing determination of a working direction.

FIG. 8 is a diagram showing the constructions of a bore inner surface inspecting system having a surface inspecting device according to a second embodiment of the present invention and a cylinder block having a bore as an inspection target.

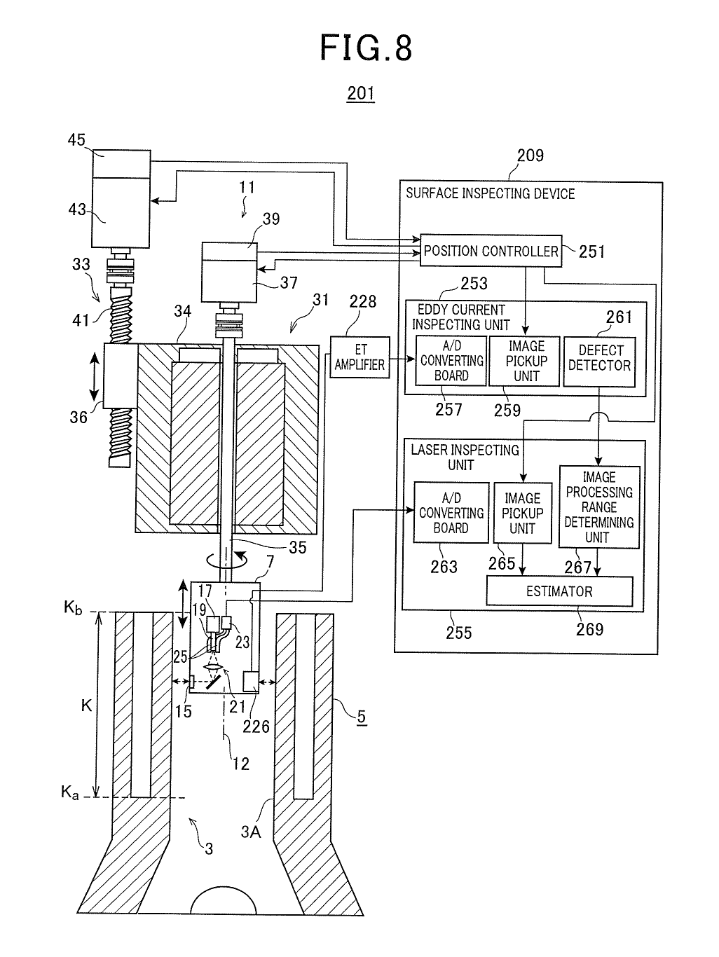

FIG. 9 is a diagram showing an image generated through bore inner surface inspection along inspection flow.

FIG. 10 is a flowchart showing bore inner surface inspecting processing.

FIG. 11 is a diagram showing the constructions of a bore inner surface inspecting system having a surface inspecting device according to a third embodiment of the present invention and a cylinder block having a bore as an inspection target.

FIG. 12 is a block diagram showing the construction of a detector.

FIG. 13 is a diagram showing the operation of an AGC unit.

FIG. 14 is a diagram showing compression of a voltage range to noise.

FIG. 15 is a diagram showing the operation of a noise compressor.

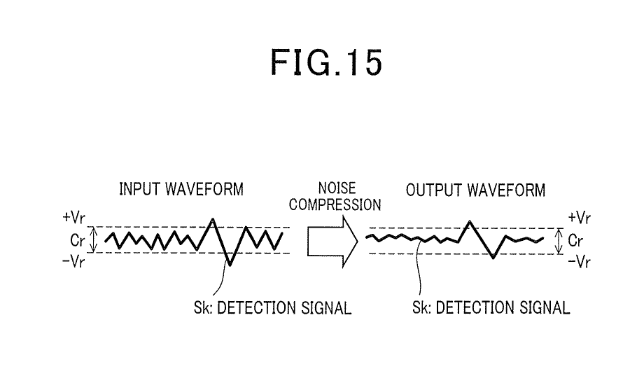

FIG. 16 is a diagram showing the operation of a threshold value determining unit.

FIG. 17 is a diagram showing variation of the level of a detection signal in accordance with the scan direction of a sensor head and the direction of a cutting work trace.

FIG. 18 is a diagram showing variation of an advancing and retreating speed of a boring head when a bore is formed.

FIG. 19 is a diagram showing a cutting work trace on the inner surface of the bore, wherein (A) shows a place at which a cutting work trace pitch is relatively narrow, and (B) shows a place at which the cutting work trace pitch is relatively broad.

FIG. 20 is a diagram showing waveforms of detection signals of the sensor head when a normal face, a grinding store flaw and a polishing residue are scanned with respect to an end portion area and an intermediate area.

FIG. 21 is a diagram showing the relationship between a scan position of the sensor head and a flaw determining threshold voltage.

FIG. 22 is a diagram showing change of a compressed range voltage corresponding the scan position of the sensor head.

FIG. 23 is a diagram showing a state that the flaw determining threshold voltage is changed in accordance with the scan position of the sensor head.

### EMBODIMENTS FOR CARRYING OUT THE INVENTION

Embodiments according to the present invention will be described hereunder with reference to the drawings.

### First Embodiment

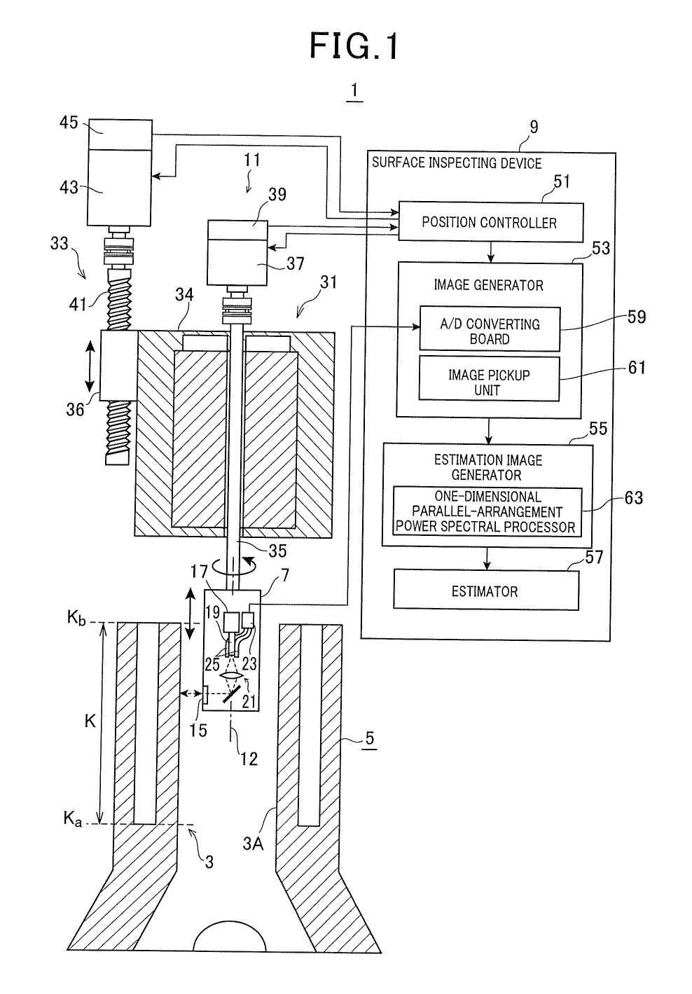

FIG. 1 is a diagram showing the constructions of a bore inner surface inspecting system having a surface inspecting device 9 according to an embodiment and a cylinder block 5 having a bore 3 as an inspection target therein.

The bore 3 is formed by a so-called boring work as a machining work for mounting a cutting bite on a boring head provided to a rotating shaft so that the cutting bite projects in a radial direction from the boring head and advancing/retreating the boring head to/from a cylinder block as a workpiece while rotating the boring head. A spiral cutting work trace having directionality can be formed on the inner surface 3A of the bore 3 by the boring work. Thereafter, the inner surface 3A of the bore 3 is subjected to a honing work by using a working head having a honing stone disposed thereon with keeping an oil pit so as to achieve a surface roughness and a surface property which enable an engine to exercise a desired performance.

The bore inner surface inspecting system estimates the presence or absence of a polishing residue on the basis of a digital image obtained by picking up an image of the inner surface 3A of the bore 3, and it has a sensor head 7 for scanning the inner surface 3A of the bore 3, a surface inspecting device 9 for generating a digital image on the basis of an output signal of the sensor head 7 and estimating a polishing residue on the basis of the digital image, and a driving mechanism 11 for moving and driving the sensor head 7.

The sensor head 7 is formed in a cylindrical shape so that the sensor head 7 can enter the bore 7, and secured to the driving mechanism 11 so as to be rotatable around a center axial line 12 and a movable along the center axial line 12. The sensor head 7 applies a laser beam from an opening 15 formed in the peripheral surface thereof to the inner surface 3A of the bore 3, and detects a reflection light amount corresponding to the shape and depth of a cutting work trace.

Specifically, the sensor head 7 has an LD (laser diode) 17 as a light source, an optical fiber 19 and a focusing optical unit 21, and it leads light of LD 17 to the focus optical unit 21 through the optical fiber 19, focuses the light by the focusing optical unit 21 and then emits a laser beam from the opening 15. Furthermore, the sensor head 7 has a photodetecting sensor 23 for receiving reflection light, and plural optical fibers 25 for guiding reflection light returning through the focusing optical unit 21 to the photodetecting sensor 23 are disposed to be adjacent to the optical fiber 19.

The driving mechanism 11 has a rotational driving mechanism 31 for rotating the sensor head 7, and an advancing/retreating mechanism 33 for advancing/retreating the rotational driving mechanism 31.

The rotational driving mechanism 31 has a housing 34, a shaft 35 which is provided with the sensor head 7 at the tip thereof and penetrates vertically through the housing 34, a shaft motor 37 which rotates the shaft 35 under the control of a surface inspecting device 9, and a rotary encoder 39 for detecting the rotational speed and rotational angle of the shaft 35 and outputting them to the surface inspecting device 9.

An advancing/retreating mechanism 33 is a feeding screw mechanism, and has a threaded shaft portion 41, an advancing/retreating motor 43 for rotationally driving the shaft portion 41, and a rotary encoder 45 for detecting the rotational speed and rotational angle of the shaft portion 41 and outputting them to the surface inspecting device 9. The shaft portion 41 is threadably mounted in a nut portion 36 of the housing 34, and the shaft portion 41 is rotated by driving the advancing/retreating motor 43 to advance/retreat the rotational driving mechanism 31.

The surface inspecting device 9 has a position controller 51 for controlling the position of the sensor head 7 by controlling the driving mechanism 11, an image generator 53 for generating a digital image of the inner surface 3A of the bore 3 on the basis of a photodetection signal of the sensor head 7, an estimation image generator 55 for generating an estimation image for estimating a polishing residue on the basis of the digital image, and an estimator 57 for estimating the polishing residue on the basis of the estimation image. The surface inspecting device 9 can be constructed by executing a program which makes a personal computer implement the respective parts, for example.

The respective parts of the surface inspecting device 9 will be described in more detail. The position controller 51 contains a servo mechanism for driving the shaft motor 37 and the advancing/retreating motor 43, and controls the position of the sensor head 7 along the center axial line 12 and the rotational angle of the sensor head 7. That is, the position controller 51 inserts the sensor head 7 into the bore 3 when an inspection is started, and locates the opening 15 at the lower end position Ka of an inspection range K. An operation of upwardly moving the sensor head 7 along the center axial line 12 while the sensor head 7 is rotated around the center axial line 12 so as to trace the locus of the boring bite during a boring work is executed until the opening 15 of the sensor head 7 reaches the upper end position Kb of the inspection range K, whereby the whole surface of the inspection range K is spirally scanned by the sensor head 7. This inspection range K is determined by a range which functions as a sliding surface to the cylinder.

The image generator 53 has an A/D conversion board 59 for executing A/D conversion on the photodetection signal from the sensor head 7 and outputting the photodetection signal as a digital signal representing brightness, and an imaging unit 61 for constructing a digital brightness image 70 concerning the inspection range K of the inner surface 3A of the bore 3 on the basis of the digital signal.

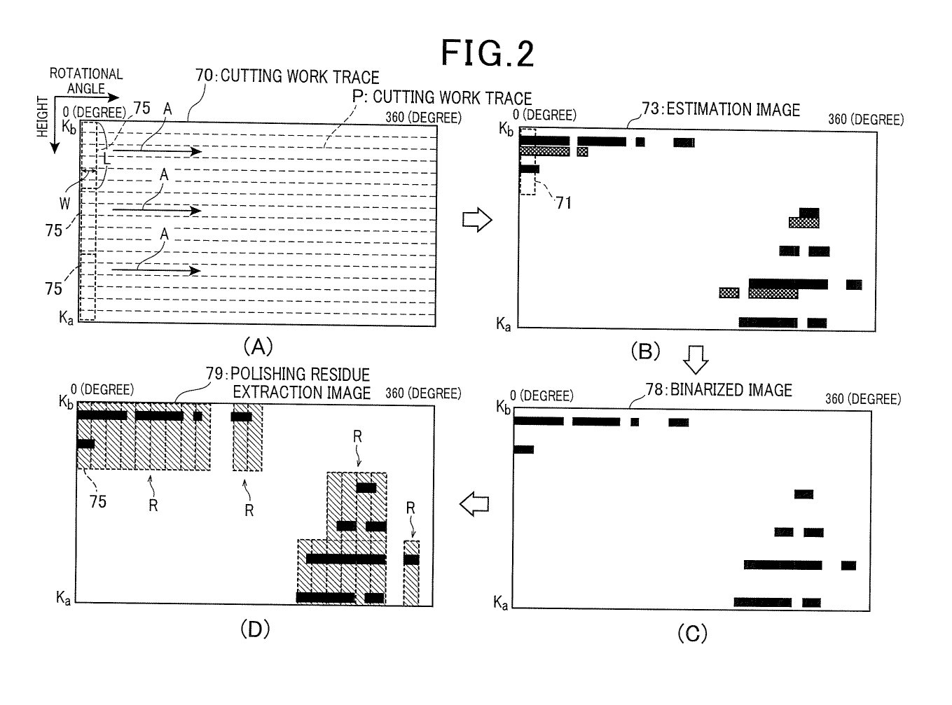

As shown in FIG. 2(A), the reflection light intensity obtained at each inspection position in the bore 3 by the sensor head 7 is imaged in association with the inspection position to thereby obtaining the digital brightness image 70. In this embodiment, the imaging is performed while the height position of the sensor head 7 and the rotational angle of the sensor head 7 are set as the ordinate axis and the abscissa axis, respectively. Broken lines in the digital brightness image 70 of FIG. 2(A) schematically represent cutting work traces P during the boring work.

As shown in FIG. 2(B), the estimation image generator 55 has a one-dimensional parallel-arrangement power spectral processor (estimation image generating means) 63 for successively generating a one-dimensional power spectral image 71 in a direction perpendicular to the direction of the cutting work traces P along the direction of the cutting work traces P on the basis of the digital brightness image 70 and arranging these one-dimensional power spectral images 71 in a generating order to generate an estimation image 73. The one-dimensional power spectral image 71 and the estimation image 73 will be described in detail later.

The estimator 57 estimates the polishing residue of the inner surface 3A of the bore 3 on the basis of the brightness value (pixel value) of each pixel of the estimation image 73.

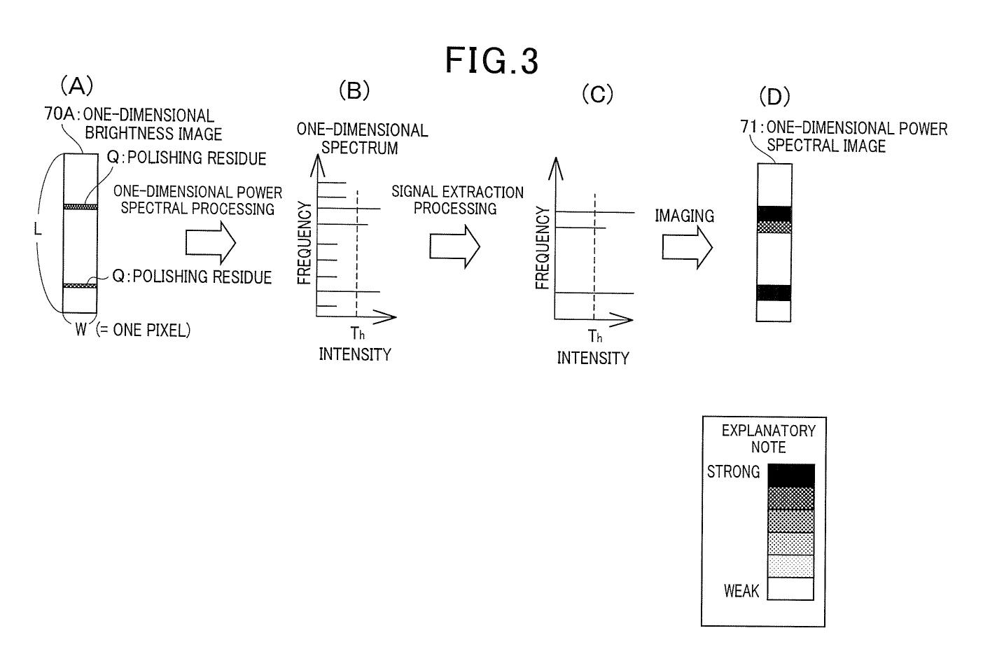

FIG. 3 is a diagram showing a process of generating a one-dimensional power spectral image 71 by the estimation image generator 55.

A column type extraction window 75 having a predetermined size for defining an area which is subjected to the one-dimensional power spectral processing in the digital brightness image 70 is provided in the estimation image generator 55 in advance. In this embodiment, the width W of the extraction window 75 is set to one pixel, and the height L thereof is set to several pixels (for example, 200 pixels). The height direction of the extraction window 75 corresponds to the one-dimensional direction of the one-dimensional power spectrum.

As shown in FIG. 2(A), the estimation image generator 55 superposes the extraction window 75 on the digital brightness image 70 so that the height direction thereof is perpendicular to the direction of the cutting work traces P, and as shown in FIG. 3(A), the image of the range corresponding to the extraction window 75, that is, the one-dimensional digital brightness image 70A having the width W of one pixel and the height L of a predetermined number of pixels is extracted. In FIG. 3(A), cutting work traces P in which polishing based on the honing work is insufficient are distinctly shown as polishing residues

Q.

Subsequently, the estimation image generator 55 subjects this one-dimensional digital brightness image 70A to one-dimensional Fourier transform to generate a one-dimensional power spectrum as shown in FIG. 3(B). In this one-dimensional power spectrum, a signal representing cutting work traces P appears every frequency component corresponding to the pitch of the cutting work traces P.

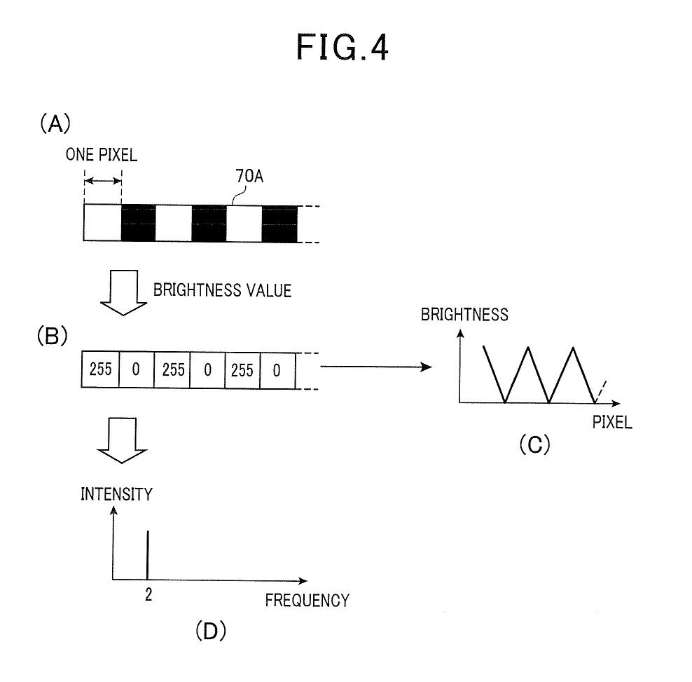

Describing in more detail, when black and while vary every pixel in the one-dimensional digital brightness image 70A as shown in FIG. 4(A), the brightness value of each pixel as shown in FIG. 4(B) is obtained. When these brightness values are represented as a brightness variation in the one-dimensional direction, the waveform of a triangular wave as shown in FIG. 4(C) is obtained. When the brightness of each pixel is represented by a power spectrum, black and white are interchanged by each other every two pixels, and thus a signal appears in the frequency component corresponding to 2 pixels/cycle in the power spectrum as shown in FIG. 4(D) . Accordingly, in the boring work, the cutting work trace P has a spiral shape having a substantially fixed pitch, and thus a signal representing the cutting work trace P appears in the frequency component corresponding to the pitch of the spiral of the cutting work trace P.

Here, as the difference in light and shade (contrast) between light reflected from the cutting work trace P and light reflected from an area other than the cutting work trace P is larger, the intensity of the signal of the one-dimensional power spectrum is increased. Normally, as the cutting work trace P is deeper, the difference in light and shade of the reflected light is larger, so that the intensity of the signal of the one-dimensional power spectrum is larger. In other works, the depth of the cutting work trace P can be determined on the basis of the signal intensity of the one-dimensional power spectrum. When the inner surface 3A of the bore 3 has an unevenness which is caused by a dent or the like in addition to the cutting work traces P, the signal whose intensity corresponds to the light and shade (contrast) of this unevenness appears as another frequency component.

Returning to FIG. 3, the estimation image generator 55 executes the following processing to extract only the cutting work trace P. That is, the cutting work trace P has a spiral shape having a substantially fixed pitch, and thus the signal representing the cutting work trace P appears in the frequency component corresponding to the pitch of the spiral. Therefore, as shown in FIG. 3(C), the frequency components other than the frequency component corresponding to the pitch of the cutting work trace P is attenuated to the intensity Th or less. As shown in FIG. 3(D), multi-value setting is execute to generate a one-dimensional power spectral image 71 according to an explanatory note in which the brightness value is lowered as the intensity of the signal is increased. Conversely to the explanatory note, the one-dimensional power spectral image 71 may be generated while the brightness value is set to be higher as the intensity of the signal is larger. Furthermore, the processing of amplifying only the signal of the frequency component corresponding to the pitch of the cutting work trace P may be executed to extract only the cutting work trace P, whereby the signal of the frequency component is made different from those of the other frequency components. Still furthermore, under the state that the signal of the frequency component corresponding to the pitch of the cutting work trace P is made different from the signals of the other frequency components, the cutting work traces P whose depths correspond to the oil pit are excluded, and only cutting work traces P whose depths are regarded as the depth of a polishing residue Q are extracted, whereby only the signals of frequency components whose intensities exceed a predetermined threshold value may be extracted.

As shown in FIG. 2(A), the processing of moving the extraction window 75 along the direction A of the cutting work trace P from the rotational angle of 0° till the rotational angle of 360° of the sensor head 7 (that is, one rotation) while a one-dimensional power spectral image 71 is generated to thereby generate a one-dimensional power spectral image 71 of one line, is executed by the estimation image generator 55 while displacing in the height direction L by only L, thereby generating the one-dimensional power spectral image 71. As shown in FIG. 2(B), an estimation image 73 is generated by arranging the one-dimensional power spectral images 71 in parallel along the direction A of the cutting work trace P. Accordingly, the image in which the one-dimensional power spectra are successively arranged in parallel in connection with the rotational angle of the sensor head 7 is obtained.

The estimator 57 estimates the polishing residue Q on the basis of the thus-obtained estimation image 73. Described in detail, in order to exclude oil pits and more surely leave only the intensities corresponding to polishing residues Q as shown in FIG. 2(C), binarization processing is executed by using a predetermined brightness threshold value so that the oil pits are discriminable, thereby generating a binarized image 78 as shown in FIG. 2(C).

Then, as shown in FIG. 2(D), the estimator 57 applies the extraction window 75 to each of the pixels remaining through the binarization processing, and this extraction window 75 is a window used to extract these pixels (that is, the one-dimensional spectral image 71 containing the pixels concerned). The area contained in the thus-applied extraction window 75 is colored to generate a color-coded polishing residue extraction image 79. Accordingly, in this polishing residue extraction image 79, ranges R in which polishing residues Q exist are color-coded and clearly specified.

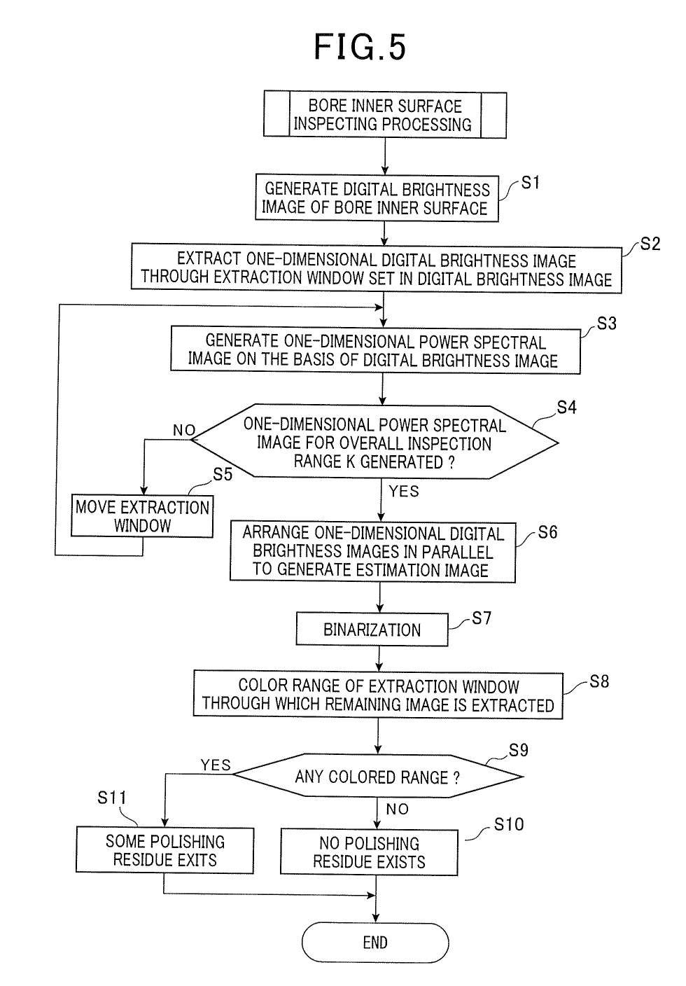

FIG. 5 is a flowchart showing the bore inner surface inspecting processing based on the bore inner surface inspecting system 1.

In the bore inner surface inspecting processing, after the cylinder block 5 having the bore 3 as an inspection target formed therein is set at a predetermined position just below the driving mechanism 11 of the cylinder block 5, the surface inspecting device 9 makes the sensor head 7 enter the bore 3 under the control of the position controller 51, advances and retreats the sensor head 7 while rotating the sensor head 7 to scan the inner surface 3A of the bore 3 over an inspection range K, and generates a digital brightness image 70 of the inspection range K on the basis of a signal obtained through this scan by the image generator 53 (step S1). Subsequently, the one-dimensional power spectral processor 63 of the estimation image generator 55 superimposes the extraction window 75 extending in the direction perpendicular to the cutting work trace P on the digital brightness image 70 to extract a one-dimensional digital brightness image 70A from the range of the extraction window 75 (step S2). The one-dimensional power spectral processor 63 generates the one-dimensional power spectral image 71 from the one-dimensional digital brightness image 70A (step S3). The one-dimensional power spectral processor 63 repeats the processing of generating the one-dimensional spectral image 71 while moving the extraction window 75 along the cutting work trace P in the digital brightness image 70 (step S5) until one dimensional power spectral images 71 over the whole inspection range K are generated (during the period for which determination of the step S4 is No). Subsequently, the one-dimensional power spectral processor 63 arranges these one-dimensional power spectral images 71 in parallel in generation order to generate an estimation image 73 (step S6).

Subsequently, the estimator 57 executes binarization processing on the estimation image 73 on the basis of a predetermined brightness threshold value to leave only the intensity corresponding to the polishing residue Q to generate a binarized image 78(step S7). Subsequently, the estimator 57 colors the range of the extraction window 75 serving to extract the pixels remaining after the binarization processing (that is, all the pixels of the one-dimensional power spectral image 71 containing the remaining pixels) to color-code the range, thereby generating a polishing residue extraction image 7979 (step S8). When no colored range exists in the polishing residue extraction image 79 (step S9: NO), the estimator 57 estimates that no polishing residue Q exists on the inner surface 3A of the bore 3 (step S10), and when a colored range exists (step S9: YES), the estimator 57 estimates that there is some polishing residue Q (step S11).

When there is a polishing residue Q, the polishing residue extraction image 79 is displayed on a monitor device (not shown) and presented to a worker. The worker can determine the size of the polishing residue Q from the breadth of the colored range by watching this polishing residue extraction image 79. Furthermore, the position at which a polishing residue Q exists can be easily determined on the basis of the position of the colored range, and thus the polishing residue Q can be easily found when the worker actually checks with his/her eye.

As described above, according to this embodiment, the one-dimensional power spectral image 71 is generated under the state that the direction perpendicular to the direction A of the cutting work trace P is set to the one-dimensional direction. In the one-dimensional power spectrum, a signal corresponding to the depth of a cutting work trace P appears at the frequency component corresponding to the pitch of the cutting work trace P, so that only the cutting work trace P can be efficiently extracted while being discriminated from other uneven portions on the inner surface 3A of the bore 3 to generate the one-dimensional power spectral image 71.

By arranging these one-dimensional power spectral images 71 in parallel, an image in which the juxtaposing direction corresponds to the direction of cutting work trace P is obtained as the estimation image 73.

Accordingly, the presence or absence of the polishing residue Q of the cutting work trace P can be efficiently estimated on the basis of the pixel values of the estimation image 73, and also the range R in which the polishing residue Q exists can be specified. Furthermore, the size (extending length) of the polishing residue Q can be determined on the basis of the spreading of this range R in the arranging direction.

Accordingly, the presence or absence of the polishing residue Q, the locating place of the polishing residue Q and the size thereof can be determined, and thus it can be easily determined whether the bore 3 is good or bad. Furthermore, a place at which the polishing residue Q exists can be marked out in advance when the worker actually checks with his/her eye. Therefore, the place concerned can be easily found out and thus the inspection time can be shortened.

Furthermore, according to this embodiment, in the polishing residue extraction image 79 obtained by binarizing the estimation image 73, the pixels left through the binarization are color-coded together with the respective pixels of the one-dimensional power spectral image 71 containing the former pixels. Accordingly, the range R in which each polishing residue Q exists is clarified, and the worker can easily find out the place of the polishing residue Q when the work checks visually.

The above first embodiment is an embodiment of the present invention, and any modification can be made in the scope of the present invention.

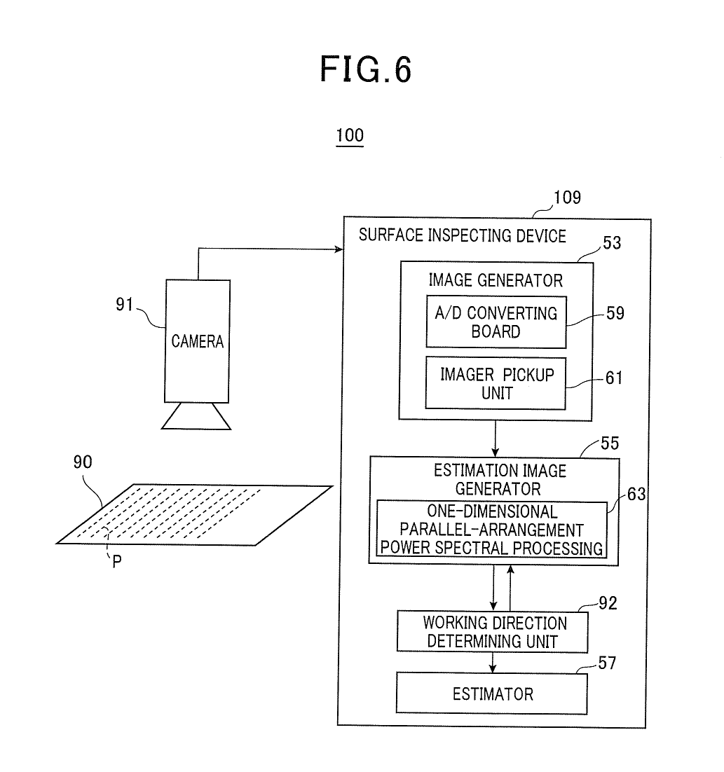

For example, in the first embodiment, the device for inspecting the inner surface 3A of the bore 3 is described. However, the present invention is not limited to the device for inspecting the machined surface of a hole like the bore 3. That is, the present invention may be also applied to a device for inspecting a machined surface obtained by executing a cutting work on a flat surface of a workpiece 90 at a substantially equal pitch in the same direction as shown in FIG. 6. In this case, the machines surface is a flat surface, and thus a digital brightness image 70 of the overall machined surface can be picked up by only one image pickup operation of a camera 91.

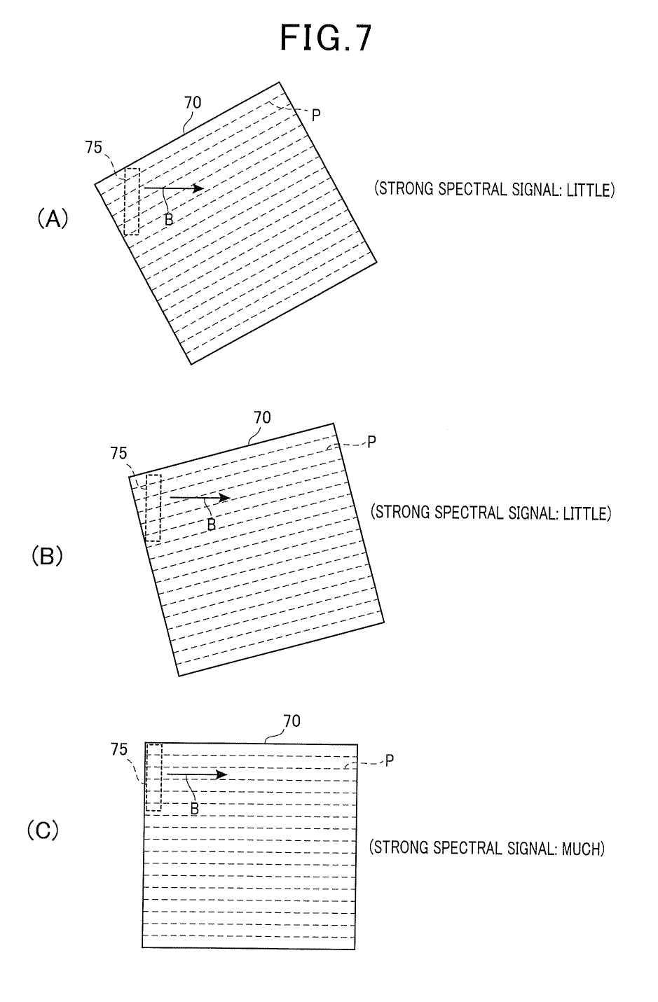

Even when the machining direction (the direction of the cutting work traces P) is not known, the estimation image 73 obtained by arranging the one-dimensional power spectral images 71 along the direction of the cutting work traces P as follows can be obtained. That is, as shown in FIGS. 7(A) to 7(C), the digital brightness image 70 of the machined surface is rotated every predetermined angle. The one-dimensional power spectral images 71 are successively generated and arranged in parallel along the direction B perpendicular to the one-dimensional direction (the height direction) of the one-dimensional power spectrum every rotation to thereby generate the estimation image 73.

At this time, a largest number of strong spectral signals appear in the estimation image 73 at a rotational position at which the one-dimensional direction (height direction) of the one-dimensional power spectrum and the direction of the cutting work traces P are perpendicular to each other. Therefore, by specifying this estimation image 73, the estimation images 73 comprising the one-dimensional power spectral images 71 arranged along the direction of the cutting work traces P can be obtained, and also the cutting work direction can be also specified.

As shown in FIG. 6, the surface inspecting device 109 of the surface inspecting system 100 is configured to have the working direction determining unit 92 for determining the cutting work direction as described above, whereby the surface inspecting device 109 which can estimate a machined surface of even a workpiece 90 for which the direction of the cutting work traces P is not known can be constructed.

### Second Embodiment

In a conventional technique (JP-A-2004-132900), image processing is executed on digital images over the whole area of the inner surface of the bore, and thus the time required for inspection is long, which disturbs enhancement of engine productivity. In addition, there is a problem that when foreign material such as water droplet, dust or the like adheres to the inner surface of the bore, this foreign material is pictured on the digital image and thus it is erroneously determined as a defect.

Therefore, according to this embodiment, there will be described a surface inspecting device 209 which is not affected by foreign materials on the surface thereof and surely narrows down a range to be subjected to image processing, whereby the time required for inspection can be shortened.

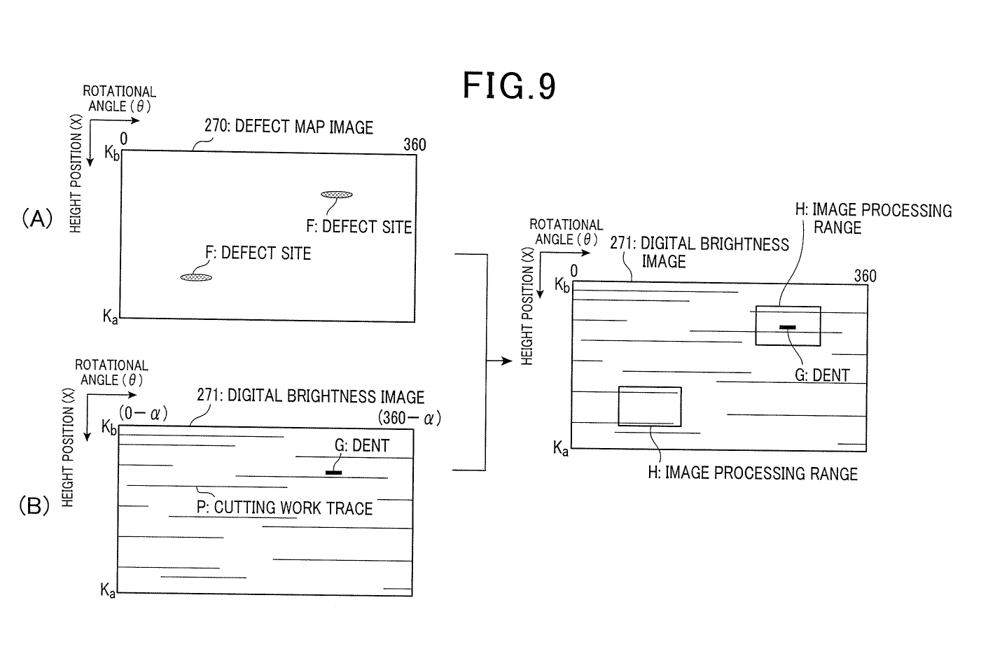

FIG. 9 is a diagram showing the construction of a bore inner surface inspecting system 201 having a surface inspecting device 209 according to a second embodiment of the present invention, and a cylinder block 5 having a bore 3 as an inspection target formed therein. In FIG. 9, the elements described with reference to the first embodiment are represented by the same reference numerals, and the description thereof is omitted.

An eddy current inspecting sensor 226 is contained in the sensor head of this embodiment . The eddy current inspecting sensor 226 has a coil for making eddy current flow through the inner surface 3A of the bore 3 and detecting current induced by electromagnetic induction, and the detected current is amplified b y an ET amplifier 228 and then input to the surface inspecting device 209. The current induced by the electromagnetic induction varies in accordance with unevenness of the inner surface 3A of the bore 3 and the presence or absence of an internal cavity, and thus a defect can be detected by detecting a site at which the current based on the electromagnetic induction varies. Furthermore, the current based on the electromagnetic induction is hardly affected by water droplets, dust or the like which adheres to the inner surface 3A of the bore 3, and thus erroneous determination caused by water droplets, dust or the like can be prevented as compared with defect determination based on irradiation of laser beam.

The eddy current inspecting sensor 226 is provided to the sensor head 7 so that defect detection can be performed at the same height position as the irradiation position of the laser beam. Accordingly, the generation of the digital image and the defect detection based on the eddy current inspecting sensor 226 can be simultaneously performed at the same height position of the bore 3.

The surface inspecting device 209 has a position controller 251 for controlling the position of the sensor head 7 by controlling the driving mechanism 11, an eddy current inspecting unit 253 for detecting a defect of the bore 3 on the basis of a detection signal of the eddy current inspecting sensor 226, and a laser inspecting unit 255 for generating a digital image of the inner surface 3A of the bore 3 on the basis of a photodetection signal of the sensor head 7 and estimating on the basis of the digital image whether the bore 3 is good or bad. The surface inspecting device 20 may be constructed by making a personal computer execute a program for implementing each part, for example.

Each part of the surface inspecting device 209 will be described in more detail. The position controller 251 contains a servo mechanism for driving the shaft motor 37 and the advancing/retreating motor 43, and controls the position along the center axial line 12 of the sensor head 7 and the rotational angle of the sensor head 7. That is, the position controller 251 inserts the sensor head 7 into the bore 3 when an inspection is started, and locates the opening 15 and the eddy current inspecting sensor 226 at the lower endposition Ks of the inspection range K. Then, an operation of upwardly moving the sensor head 7 along the center axial line while rotating the sensor head 7 around the center axial line 12 so as to tracing the locus of the boring bite under boring processing is executed until the opening 15 and the eddy current inspecting sensor 226 of the sensor head 7 reaches the upper position Kb of the inspecting range K, whereby the overall surface of the inspection range K is spirally scanned by the sensor head 7. This inspection range K is determined by the range serving as a sliding face to the cylinder.

The eddy current inspecting unit 253 has an A/D conversion board 257 for executing A/D conversion on the detection signal of the eddy current inspecting sensor 226 of the sensor head and outputting a digital signal whose intensity value corresponds to the presence or absence of a defect, an imaging unit 259 for generating a defect map image 270 (FIG. 9) on the basis of this digital signal, and a defect detector 261 for detecting a defect site F on the basis of the defect map image 270.

As shown in FIG. 9(A), the defect map image 270 is generated by associating the detection signal of the eddy current inspecting sensor 226 with the detection position, and according to this embodiment, the image is generated while the height position X of the sensor head 7 and the rotational angle θ of the sensor head 7 are set to the ordinate axis and the abscissa axis, respectively. In this defect map image 270, a site at which the detection signal of the eddy current inspecting sensor 226 varies due to a defect such as a dent, a cutting work trace P, a cavity or the like appears as a defect site F. The defect site F is detected by the defect detector 261, and the position coordinate (X, θ) defined by the height position X and the rotational angle θ is output to the laser inspection unit 255.

The laser inspecting unit 255 has an A/D conversion board for executing A/D conversion on the photodetection signal from the sensor head 7 and outputting a digital signal representing the brightness, an imaging unit 265 for generating a digital brightness image 271 on the basis of this digital signal, an image processing range determining unit 67 for determining an image processing range H for the digital brightness image 271 on the basis of the position coordinate of the defect site F detected by the defect detector 261 of the eddy current inspecting unit 253, and an estimator 269 for executing image processing on the image processing range H and estimating on the basis of the result of the image processing whether the bore 3 is good or bad.

As shown in FIG. 9(B), the digital brightness image 27 is generated by associating each inspection position with the reflection light intensity obtained by the sensor head 7 at the inspection position. In this embodiment, the image is generated while the height position X of the sensor head 7 and the rotational angle θ of the sensor head 7 are set to the ordinate axis and the abscissa axis respectively as in the case of the defect map image 270.

Here, both the irradiation of a laser beam and the detection based on the eddy current inspecting sensor 226 are simultaneously performed during the period when the sensor head 7 is moved from the lower end position Ka to the upper end position Kb in the bore 3. Accordingly, a phase difference a corresponding to the mount interval between the opening 15 and the eddy current inspecting sensor 226 occurs between the irradiation position of the laser beam and the detection position of the eddy current inspecting sensor 226. Therefore, when the digital brightness image 271 is generated, the imaging unit 265 corrects the rotational angle θ at the detection position with the phase difference α and generates the digital brightness image so that the position coordinate thereof is equal to the position coordinate of the defect map image 270.

As shown in FIG. 9(B), cutting work traces P under the boring work, a dent occurring due to impingement of a tool such as a boring bite or the like, etc. are pictured on the digital brightness image 271. According to the conventional surface inspecting device, the binarization processing and the power spectral calculation processing are executed on the overall digital brightness image 271 to exclude oil pits from the detected cutting work traces P and extract harmful defects such as cutting work traces P such as polishing residue, etc., dents G, etc. Therefore, much processing time is required. On the other hand, according to this embodiment, as described above, the image processing range determining unit 267 limits the range to be subjected to the image processing to an image processing range H containing a defect site F, whereby the processing speed can be increased.

Describing in detail, when the position coordinate (X, θ) of the defect site F detected by the eddy current inspecting sensor 226 is input from the defect detector 261, the image processing range determining unit 267 defines, as an image processing range H, a rectangular area of a predetermined range containing this position coordinate (X, θ) at the center thereof.

Accordingly, as shown in FIG. 9(C), when a dent G exists on the inner surface of the bore 3, the range containing the dent G is determined as the image processing range H. In the eddy current inspection, not only surface detects such as a dent G, a cutting work trace P, etc., but also an internal defect such as a cavity or the like is also detected, and thus these cannot be discriminated from one another by only the eddy current inspection result. Therefore, when an internal defect such as a cavity or the like is detected by the eddy current inspecting unit 25, the digital brightness image 271 also determines an image processing range H for a range in which conspicuous unevenness such as a dent G, a cutting work trace P or the like is not observed as shown in FIG. 9(C).

The size of the image processing range H may be a fixed value or a variable value. That is, when the surface inspecting device is configured so that a rough range of a defect site F is input from the defect detector 261 to the image processing range determining unit 267, the image processing range H is varied so as to contain the range concerned. Furthermore, when the surface inspecting device is configured so that only the center position of a defect site F is input from the defect detector 261 to the image processing range determining unit 267, for example, a range which is defined in advance in consideration of a normally potential dent G or polishing residue (for example, all directions within 10 μm) is used as the image processing range H.

The estimator 269 discriminates the surface defect and the inner defect from each other by subjecting each image processing range H to the image processing, and extracts only surface defects such as a dent G, a cutting work trace P, etc. Then, the sizes (dimensions) of the dent G, the cutting work trace P, etc. are determined by the image processing, and identifies whether these defects are oil pits or harmful defects interfering with the function of the sliding surface. In the case of the harmful defects, it is estimated that the bore 3 is defective.

Binarization processing in which an image is binarized by using, as a threshold value, a brightness value when a dent G or a cutting work trace P exists, thereby obtaining an image representing the presence or absence of the dent G or the cutting work trace P can be used as the image processing of the estimator 269. Through this binarization processing, the presence or absence of the dent G or the cutting work trace P can be detected, and the sizes thereof can be specified. When neither dent G nor cutting work trace P is detected through the binarization processing, an internal defect such as a cavity or the like is detected by the eddy current inspection, and thus the internal defect can be discriminated.

In spite of the binarization processing, a power spectral image for an image processing range H may be attained, and unevenness of the image processing range H may be determined so that the bore 3 can be estimated in accordance with the rate of occurrence of the unevenness. Furthermore, as described with reference to the first embodiment, the estimation can be also performed by using the one-dimensional power spectral image.

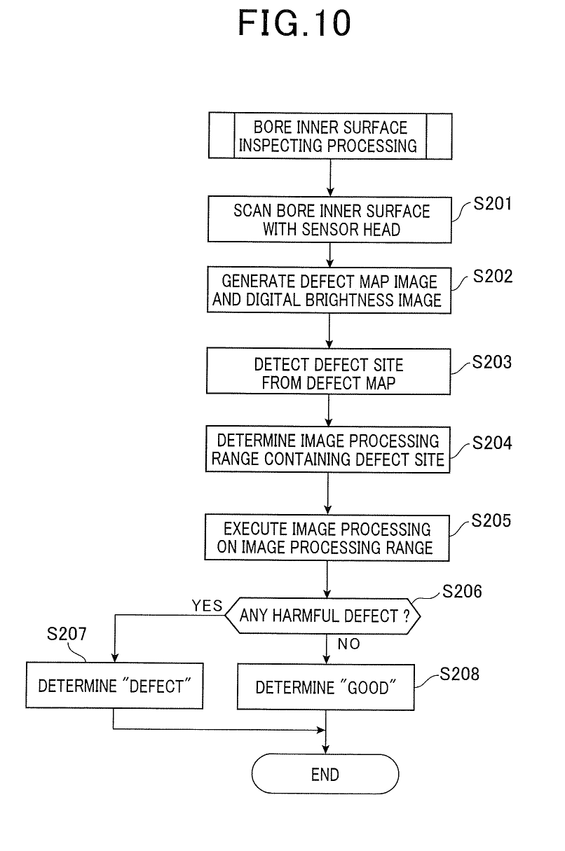

FIG. 10 is a flowchart showing the bore inner surface inspection processing of a bore inner surface inspecting system 201.

In the bore inner surface inspection processing, after the cylinder block 5 having the bore 3 as the inspection target formed therein is set at a predetermined position just below the driving mechanism 11, the position controller 251 makes the sensor head 7 enter the bore 3, and advances/retreats the sensor head 7 while rotating the sensor head 7, thereby scanning the inner surface 3A of the bore 3 over an inspection range K (step S201). Then, the eddy current inspecting unit 253 generates a defect map image 270 on the basis of the detection signal of the eddy current inspecting sensor 226 which is obtained during this scan, and the laser inspecting unit 255 generates a digital brightness image 271 on the basis of the reflection light amount of the laser beam (step S202).

Subsequently, the eddy current inspecting unit 253 detects a defect site F and position information (X, θ) of the defect site F from the defect map image 270 (step S203), and outputs the detection result to the laser inspecting unit 255. On the basis of the position information (X, θ) of the defect site F, the laser inspecting unit 255 determines an image processing range H so that the defect site F is contained in a range to be subjected to the image processing (step S204), and the estimator 269 subjects the image processing range H to the image processing such as the binarization processing, etc. for detecting a defect (step S205). When a harmful defect which is a relatively large defect such as a dent G, a cutting work trace P such as polishing residue or the like and interferes with the function of the sliding surface is detected as a result of the image processing (step S206: YES) , the bore 3 is determined to be defective (step S207). When no harmful defect is detected (step S206: NO), the bore 3 is determined to be good (step S208).

As described above, according to this embodiment, the inner surface 3A of the bore 3 is scanned by the eddy current inspecting sensor 226 to detect a defect. Therefore, even when foreign material such as a water droplet, dust or the like adheres to the inner surface 3A, defects can be detected without being affected by the foreign material.

Furthermore, although the accurate size of the defect detected by the eddy current inspection and whether the defect is a surface flaw or an internal defect such as a cavity or the like cannot be determined on the basis of the detection signal of the eddy current inspecting sensor 226, the size of the defect can be determined because the image processing can be executed on the image processing range H containing the defect site F, and thus it can be discriminated for the detected cutting work trace P whether it is an oil pit or polishing residue. Accordingly, only a harmful defect such as polishing residue, a dent G or the like can be accurately determined, and also the range to be subjected to the image processing is narrowed down to the image processing range H, so that the time required for the inspection can be shortened.

Furthermore, according to this embodiment, the sensor head 7 is provided with the eddy current inspecting sensor 226, and thus both the generation of the digital brightness image 271 based on irradiation of laser beam and the defect detection based on the eddy current inspecting sensor 226 can be performed by only one scanning operation.

The second embodiment described above is merely an embodiment of the present invention, and any modification can be made within the scope of the present invention.

For example, the second embodiment relates to the device for inspecting the inner surface 3A of the bore 3, however, the present invention is not limited to the device for inspecting a machined surface of a hole such as a bore 3. That is, the present invention may be applied to a device for inspecting a flat surface of a workpiece. In this case, since the surface is flat, a digital brightness image of the overall surface can be obtained by only one image pickup operation using a camera or the like.

### Third Embodiment

In the cutting work of the bore in the cylinder block, the advancing/retreating speed of the boring bite for the cylinder block is not necessarily constant. Therefore, the pitch of the spiral working traces formed on the inner surface of the bore varies in accordance with the advancing/retreating speed, and thus the directions of the working traces are not uniform.

In a prior art (JP-A-2004-132900), the variation of the light amount of reflection light obtained through the scan of the sensor head is dependent on the displacement between the scan direction of the sensor head and the direction of the working traces. That is, when the sensor head is scanned along the direction of the working trace, the variation of the light amount of the reflection light is small, and the variation of the light amount of the reflection light is larger as the intersecting angle to the direction of the working trace approaches to 90°.

Accordingly, when the unevenness of the inner surface of the bore is detected on the basis of the light amount variation of the reflection light obtained by the scan of the sensor head, it may cause erroneous detection of a flaw or leakage of detection.

Therefore, according to this embodiment, a surface inspecting device 309 which can enhance the flaw inspecting precision of the inner surface of the bore will be described.

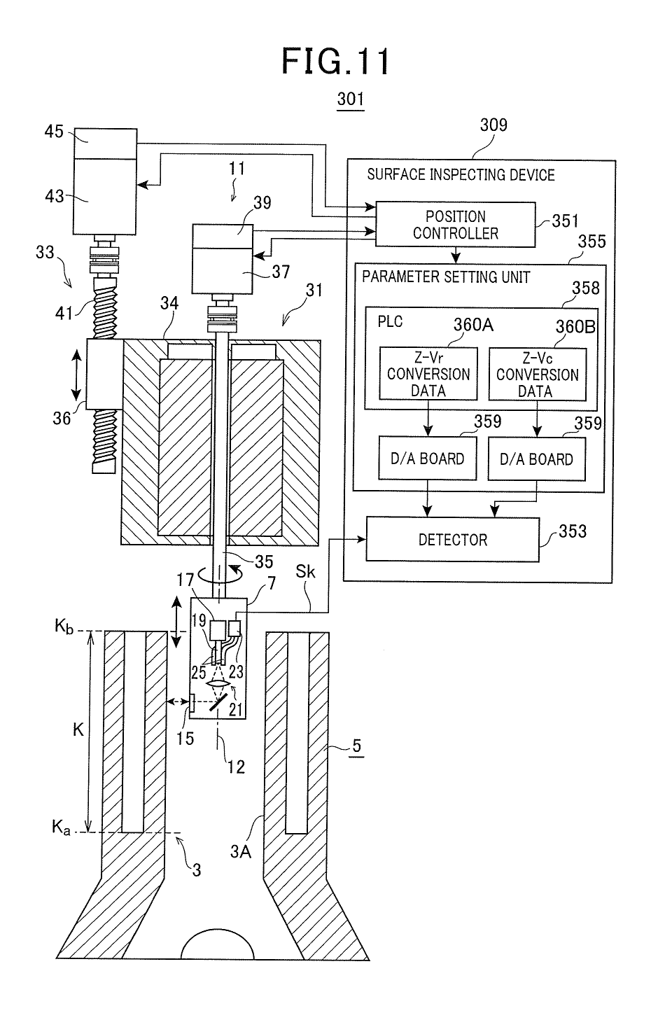

FIG. 11 is a diagram showing the construction of a bore inner surface inspecting system 1 having a surface inspecting device 309 according to a third embodiment of the present invention and a cylinder block 5 having a bore 3 as an inspection target formed therein. In FIG. 11, the elements described with reference to the first embodiment are represented by the same reference numerals, and the description thereof is omitted.

A bore inner surface inspecting system 301 scans the inner surface 3A of the bore 3 with light to estimate the presence or absence of a flaw of the inner surface 3A. That is, the bore inner surface inspecting system 301 has a sensor head 7 for scanning the inner surface 3A of the bore 3, a surface inspecting device 309 for estimating a flaw on the basis of a detection signal Sk of the sensor head 7 and a driving mechanism 11 for moving the sensor head 7. The photodetecting sensor 23 of the sensor head 7 detects the reflection light amount corresponding to the shape of the cutting work trace P, and outputs the detection signal Sk to the surface inspecting device 309.

The surface inspecting device 309 has a position controller 351 for controlling the driving mechanism 11 to control the position of the sensor head 7 in the bore 3, a detector 353 for detecting flaws of the inner surface 3A of the bore 3 on the basis of the detection signal Sk of the sensor head 7, and a parameter setting unit 355 for changing parameters used in the detector 353 in accordance with the scan position of the bore 3 based on the sensor head 7.

The respective parts of the surface inspecting device 309 will be described in more detail. The position controller 351 contains a servo mechanism for driving a shaft motor 37 and an advancing/retreating motor 43, and controls the position along the center axial line 12 of the sensor head 7 and the rotational angle. That is, the position controller 351 inserts the sensor head 7 into the bore 3 when the inspection is started, and locates the opening 15 of the sensor head 7 at the lower end position

Ka of the inspection range K. Then, the inner surface 3A is scanned while moving the sensor head 7 in the height direction so that the opening 15 of the sensor head 7 reaches the upper end position Kb of the inspection range K. Thereafter, the sensor head 7 is inched at a predetermined angle (for example, 30°), and this upper and lower motion of the sensor head 7 is repeated to scan the overall surface of the inspection range K with the sensor head 7. This inspection range K is determined by the range serving as the sliding surface to the cylinder.

When the detection signal Sk of he sensor head 7 is input to the detector 353, the detector 353 compares the detection signal Sk with a flaw detecting threshold voltage Vc as a threshold voltage for determining a flaw, and outputs a flaw determining signal representing a comparison result. This flaw determining signal is set to Hi level when the detection signal Sk is over the flaw determining threshold voltage Vc, and detects whether a signal of Hi level is contained in the flaw detecting signal, thereby specifying the presence or absence of the flaw. The specification result of the presence or absence of the flaw is output to a display device or a printer device, and an output destination device such as an external terminal or the like, and notified to a worker.

Furthermore, before comparing the detection signal Sk with the flaw determining threshold voltage Vc, the detector 353 subjects the detection signal Sk to noise compression to enhance the flaw determining precision. The flaw determining threshold voltage Vc is set to such a voltage value that polishing residue of the inner surface 3A of the bore 3 and a grind stone flaw which may occur in the honing work can be discriminated through the comparison with the voltage value of he detection signal Sk.

The specific construction of the detector 353 will be described in detail later.

The parameter setting unit 355 changes a compression range voltage Vr as a parameter associated with the noise compression and the flaw determining threshold voltage Vc out of parameters used in the detector 353 in accordance with the scan position Z of the sensor head 7 in synchronization with the scan of the inner surface 3A of the bore 3 based on the sensor head 7.

The construction of the parameter setting unit 355 will be described in detail. The parameter setting unit 355 has PLC (Programmable Logic Controller) 358, and a D/A board 359 for D/A conversion. In PLC 358 are stored Z-Vr conversion data 360A as data which associate the scan position Z of the sensor head 7 with the value of the compression range voltage Vr, and Z-Vc conversion data 360B as data which associate the scan position Z of the sensor head 7 with the value of the flaw determining threshold voltage Vc.

When the scan position Z of the sensor head 7 is input from the position controller 351 to the thus-constructed parameter setting unit 355, PLC 358 outputs the respective values of the compression range voltage Vr and the flaw determining threshold voltage Vc corresponding to the D/A board 359 on the basis of the Z-Vr conversion data 360A and the Z-Vc conversion data 360B, and the respective values are converted to analog signals of the voltage values corresponding to the respective values of the compression range voltage Vr and the flaw determining threshold voltage Vc and input to the detector 353.

Accordingly, in the detector 353, the compression range voltage Vr and the flaw determining threshold voltage Vc are dynamically changed in accordance with the scan position Z in synchronization with the scan of the inner surface 3A of the bore 3 based on the sensor head 7.

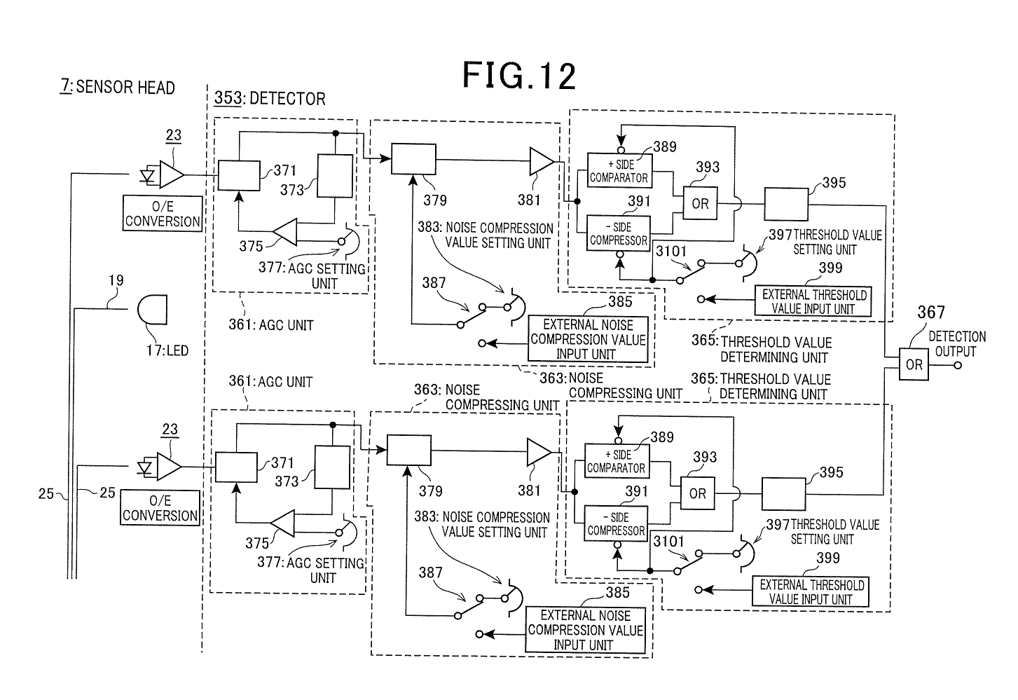

FIG. 12 is a block diagram showing the construction of the detector 353. FIG. 12 shows the construction of the sensor head 7 additionally.

The sensor head 7 is provided with plural photodetecting sensors 23. As shown in FIG. 12, each of the photodetecting sensors 23 has a photoelectric (O/E) conversion element 23A, and an amplifier 23B, and outputs, to the detector 353, the detection signal Sk of the voltage corresponding to the light amount of reflection light on the inner surface 3A of the bore 3.

The detector 353 roughly comprises AGC (Auto Gain Control) unit 361, a noise compression unit 363, a threshold value determining unit 365, and an OR circuit 367. The AGC unit 361, the noise compression unit 363 and the threshold value determining unit 365 are provided to each of the two photodetecting sensors 23. The detection signal Sk of each of the photodetecting sensors 23 is individually compared with the flaw determining threshold voltage Vc. The logical addition of each comparison result is performed and output by the OR circuit 367.

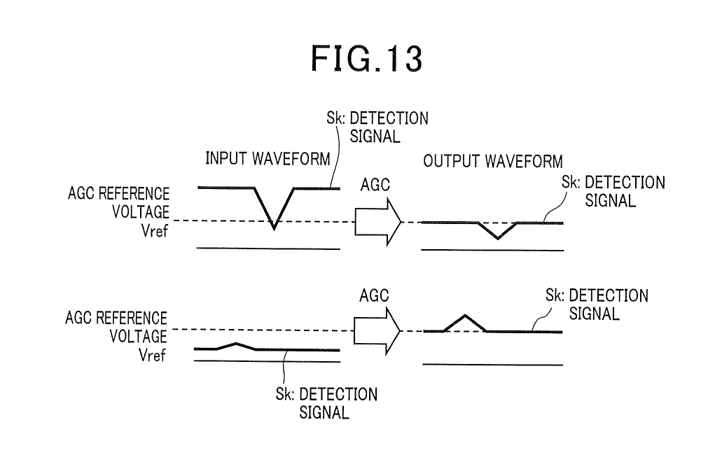

The AGC unit 361 has a signal input I/F unit 371 to which the detection signal Sk of the sensor head 7 is input, a smoothing unit 373 for smoothing a signal, and an AGC amplifier 375. The detection signal Sk is subjected to feed-back control by the AGC amplifier 375 so that the detection signal Sk of the photodetecting sensor 23 is set to have a fixed voltage level even when the voltage level of the detection signal Sk varies. Accordingly, as shown in FIG. 13, the detection signal Sk output by the sensor head 7 is output while the voltage level thereof is fit to a predetermined AGC reference voltage Vref. As shown in FIG. 12, an AGC setting unit 377 for setting the AGC reference voltage Vref is connected to the AGC amplifier 375, and thus the AGC reference voltage Vref can be set to a desired voltage value.

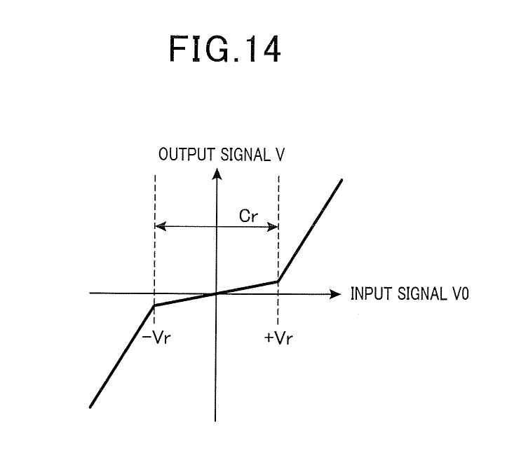

The noise compression unit 363 has a noise compression filter 379 for compressing a noise component contained in the detection signal Sk of the sensor head 7, and an amplifier 381 for amplifying the detection signal Sk after the noise compression and outputting the amplified detection signal Sk to the threshold value determining unit 365. As shown in FIG. 14, the noise compression filter 379 is a circuit for outputting an output signal V in which the input signal Vo is lowered by the voltage value of the voltage range Cr. This voltage range Cr corresponds to the range of the voltage component to be regarded as noise. Accordingly, the detection signal Sk of the sensor head 7 is input to this noise compression filter 379, whereby an output waveform in which the voltage of the noise component corresponding to the voltage range Cr is compressed is output, and a detection signal Sk whose S/N ratio is enhanced is obtained.

As shown in FIG. 12, a noise compression value setting unit 383 and an external noise compression value input unit 385 are provided so as to be selectively connectable to the noise compression filter 379 through a selecting switch 387. The noise compression value setting unit 383 is a circuit for setting the compression range voltage Vr for defining the upper limit and lower limit of the voltage range Cr to a desired fixed value. The external noise compression value input unit 385 is a circuit for inputting the compression range voltage Vr corresponding to the scan position Z of the sensor head 7, and the compression range voltage Vr is input from the parameter setting unit 355 to the external noise compression value input unit 385. The noise compression value setting unit 383 is provided for a case where a fixed value is used without dynamically changing the compression range voltage Vr in accordance with the scan position Z of the sensor head 7.

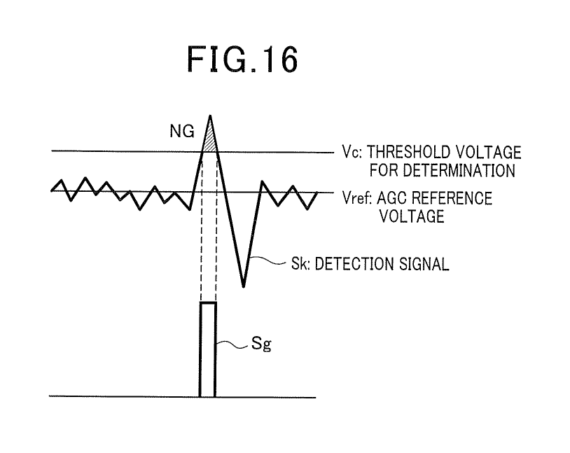

The threshold value determining unit 365 has a + (plus) side comparator 389, a − (minus) side comparator 391, an OR circuit 393, and a pulse width extending unit 395. Each of the + side comparator 389 and the − side comparator 391 compares the detection signal Sk of the sensor head 7 with the flaw determining threshold voltage Vc. As shown in FIG. 16, the + side comparator 389 outputs an output signal Sg of a predetermined voltage to the OR circuit 393 over a time period when the positive voltage of the detection signal Sk is over the flaw determining threshold voltage Vc, and the — side comparator 391 outputs an output signal Sg of a predetermined voltage to the OR circuit 393 over a time period when the negative voltage of the detection signal Sk underruns the negative value of the flaw determining threshold voltage Vc. The flaw determining threshold voltage Vc is a voltage which brings a threshold voltage for determining that a flaw exists on the inner surface 3A of the bore 3, and the output signals Sg are output from the + side comparator 389 and the − side comparator 391, thereby indicating that a flaw exists on the inner surface 3A of the bore 3.

The OR comparator 393 outputs the logical addition of the output signals Sg of the + side comparator 389 and the − side comparator 391 is output to the pulse width extending unit 395, and the pulse width extending unit 395 generates a pulse signal having a predetermined time width as a flaw determination signal and outputs it to the OR circuit 367 every time the output signal Sg is input.

As shown in FIG. 12, a threshold value setting unit 397 and an external threshold value input unit 399 are provided so as to be selectively connectable to each of the + side comparator 389 and the − side comparator 391 through a selecting switch 3101. The threshold value setting unit 397 is a circuit for setting the flaw determining threshold voltage Vc to a desired fixed value. The external threshold value input unit 399 is a circuit for inputting the flaw determining threshold voltage Vc corresponding to the scan position Z of the sensor head 7, and the flaw determining threshold voltage Vc is input from the parameter setting unit 355 to the external threshold value input unit 399. The threshold value setting unit 397 is provided for a case where a fixed value is used without dynamically changing the flaw determining threshold voltage Vc in accordance with the scan position Z of the sensor head 7.

The OR circuit 367 outputs the logical addition of the flaw determining signals output from the respective threshold value determining units 365 with respect to the respective detection signals Sk output by the two photodetecting sensors 23 of the sensor head 7. The presence or absence of the flaw is specified on the basis of this flaw determining signal. As described above, the flaw determination is individually performed every detection signal of each of the plural photodetecting sensors 23, and the final determination as to the presence or absence of the flaw is performed on the basis of the logical addition of the determination results, whereby the leakage of detection can be prevented.

Next, the relationship of the scan position Z of the sensor head 7, the compression range voltage Vr and the flaw determining threshold voltage Vc will be described below.

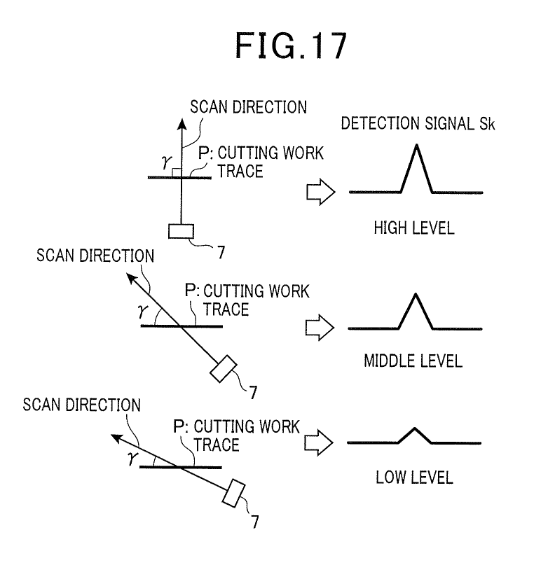

The level of the detection signal Sk of the sensor head 7 is dependent on the cutting work trace P (FIG. 17) on the inner surface 3A of the bore 3, and the level is higher as the cutting work trace P is deeper or has a larger width. Furthermore, the cutting work trace P of the bore 3 is a spiral trace, and thus the extending direction of the cutting work trace P has directionality. Accordingly, as shown in FIG. 17, the level of the detection signal Sk also varies in accordance with the scan direction of the sensor head 7 with respect to the extension direction of the cutting work trace P. That is, the level of the detection signal Sk is higher when the scan direction of the sensor head 7 is perpendicular to the extension direction of the cutting work trace P, and the level of the detection signal Sk is smaller as the intersection angle γ between the scan direction and the extension direction of the cutting work trace P is smaller (approaches to 0°.

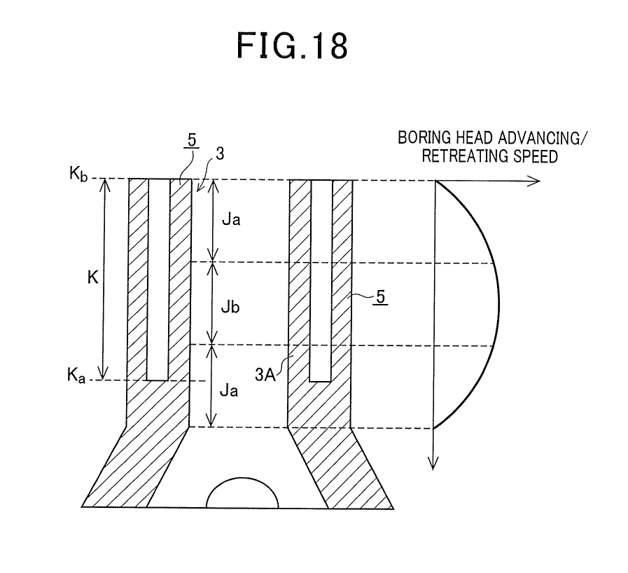

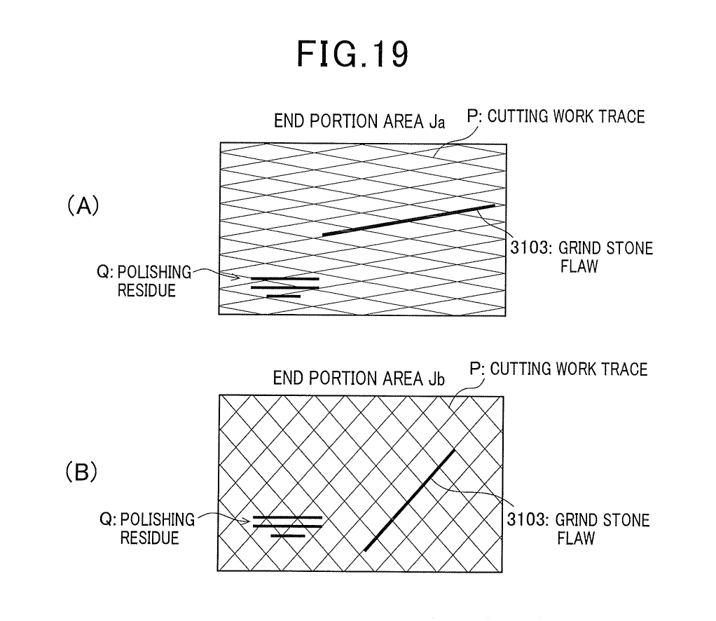

In the boring work of the bore 3, the advancing/retreating speed of the boring head is not fixed at all times, and the boring head is accelerated/decelerated as shown in FIG. 18. Due to the acceleration/deceleration of the boring head as described above, the pitch of the spiral cutting work traces P formed on the inner surface 3A of the bore 3 is not uniform. Cutting work traces P having a relatively narrow pitch as shown in FIG. 19(A) are formed in an end portion area Ja in which the acceleration/deceleration speed varies greatly, and cutting work traces P having a relatively broad pitch as shown in FIG. 19 (B) are formed in an intermediate area Jb in which the acceleration/deceleration speed of the boring head varies gently.

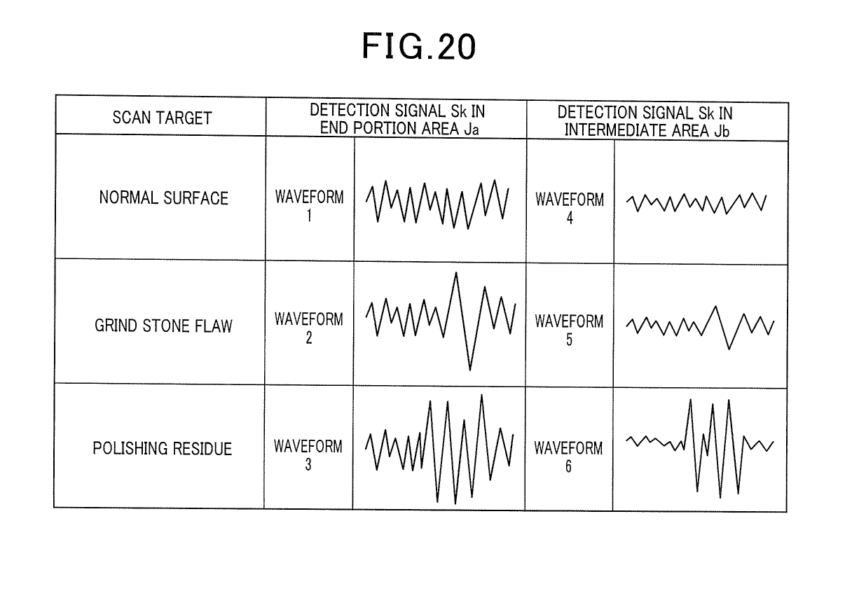

As described above, the pitch of the cutting work traces P of the bore 3 varies in accordance with the position. Therefore, when the sensor head 7 is rotated in the bore 3 and the inner surface 3A is scanned over one round, the intersection angle γ between the scan direction of the sensor head 7 and the extension direction of the cutting work traces P is different between the end portion area Ja and the intermediate area Jb. That is, even when the normal inner surface 3A is scanned by the sensor head 7, the level of the detection signal Sk of the sensor head 7 is different between the end portion area Ja and the intermediate area Jb, and for example, there is a case where the end portion area Ja is higher in level than the intermediate area Jb. The above tendency of the level difference is not limited to the scan of the normal inner surface 3A, and as shown in FIG. 20, it likewise occurs in the case of the grind stone flaw 3103 or the polishing residue shown in FIG. 19 which occurs in the honing work.

Accordingly, in a case where the flaw determination is executed on the detection signals Sk obtained in the end portion area Ja and the intermediate area Jb by applying the same flaw determining threshold voltage Vc, there occurs a case where “normality” is determined with respect to the detection signal Sk of the intermediate area Jb, however, “flaw” is erroneously determined with respect to the detection signal Sk of the end portion area Ja although similar normal surfaces are scanned. Conversely, even when a flaw such as a grind stone flaw 3103 or polishing residue Q is determined with respect to the detection signal Jk of the end portion area Ja, it may be erroneously determined with respect to the detection signal Sk of the intermediate area Jb that there is no flaw although similar surfaces having the grind stone flaw 3103 or polishing residue Q are scanned.

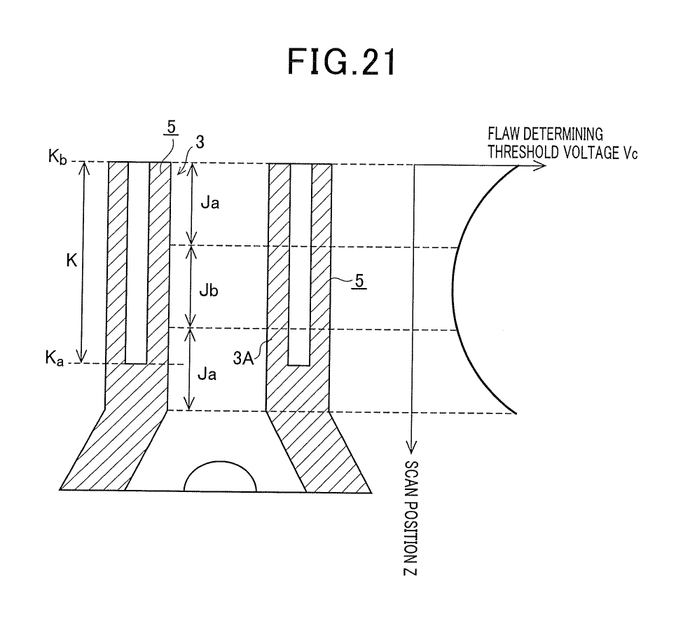

Therefore, according to this embodiment, the flaw determining threshold voltage Vc is varied in accordance with the position of the sensor head 7 in the bore 3, that is, the scan position as shown in FIG. 21. At this time, in order to vary the flaw determining threshold voltage Vc in accordance with the intersecting angle γ between the scan direction of the sensor head 7 and the extension direction of the cutting work trace, the flaw determining threshold voltage Vc is varied in conformity with the variation of the advancing/retreating speed of the boring head in the boring work of the bore 3.

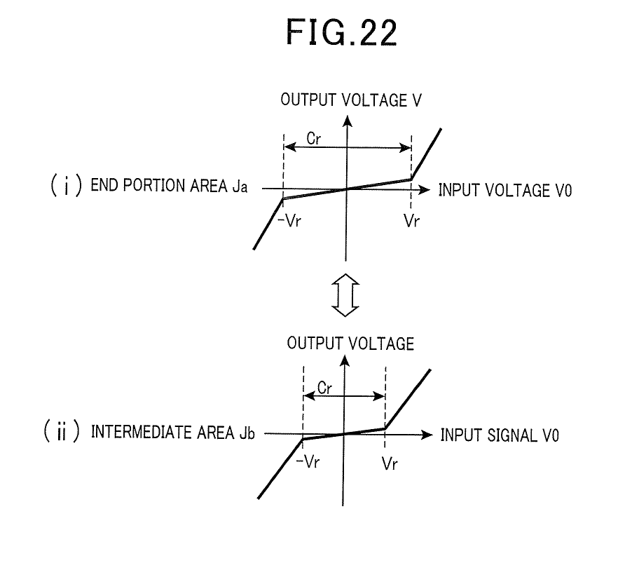

Furthermore, the level of he detection signal Sk varies in accordance with the scan position Z of the sensor head 7, and thus a voltage regarded as a noise contained in the detection signal Sk concerned also varies. Therefore, according to this embodiment, the compression range voltage Vr for defining the width of the voltage range Cr of the noise compression varies to be relatively smaller in the intermediate area Jb as compared with the end portion area Ja where the level of the detection signal Sk is relatively large as shown in FIG. 22.

The association relationship between the scan position Z of the sensor head 7 and the compression range voltage Vr as described above, and the association relationship between the scan position Z and the flaw determining threshold voltage Vc are stored as the Z-Vr conversion data 360A and the Z-Vc conversion data 360B in PLC 358 in advance.

When the inner surface 3A of the bore 3 is inspected, the parameter setting unit 355 outputs the compression range voltage Vr and the flaw determining threshold voltage Vc corresponding to the scan position Z to the detector 353 in synchronization with the scan of the inner surface 3A of the bore 3 based on the sensor head 7, and he detector 353 performs the noise compression and the flaw determination by using the compression range voltage Vr and the flaw determining threshold voltage Vc.

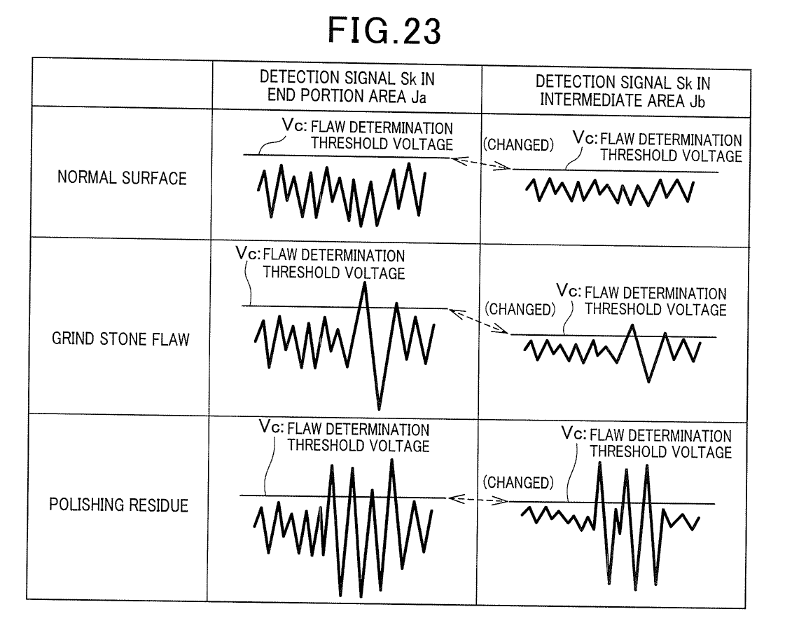

Accordingly, even when the level of the detection signal Sk varies at each scan position Z due to the direction of the cutting work trace P, the flaw determining threshold voltage Vc is dynamically changed in accordance with the scan position Z of the sensor head 7 in conformity with the variation of the level as shown in FIG. 23, and thus the erroneous determination of the flaw and the detection leakage are prevented.

When the boring work is executed so that the pitch of the cutting work traces P is fixed at each scan position of the bore 3, fixed values proper to the pitch of the cutting work traces P are set as the compression range voltage Vr and the flaw determining threshold voltage Vc in the noise compression value setting unit 383 and the threshold value setting unit 397, and these fixed values are used in the detector 353 when the inner surface 3A of the bore 3 is inspected.

As described above, according to this embodiment, the flaw determining threshold voltage Vc to be compared with the detection signal Sk of the sensor head 7 is changed in accordance with the intersecting angle γ between the scan direction of the sensor head 7 to the inner surface 3A of the bore 3 and the direction of the cutting work traces P. Therefore, the flaw detection precision of the inner surface 3A of the bore 3 can be enhanced without being affected by the scan direction and the direction of the cutting work traces P at the scan position Z.

Furthermore, according to this embodiment, the voltage range Cr to be subjected to the noise compression is changed in accordance with the intersecting angle γ between the scan direction of he sensor head 7 to the inner surface 3A of the bore 3 and the direction of the cutting work traces P. Therefore, S/N of the detection signal Sk output from the sensor head 7 can be enhanced without being affected by the scan direction and the direction of the cutting work traces Pat the scan position Z.

Still furthermore, according to this embodiment, the analog signal of the voltage value representing the flaw determining threshold voltage Vc is directly input from the D/A board 359 of the parameter setting unit 355 to each of the + side comparator 389 and the − side comparator 391 for comparing the detection signal Sk of the sensor head 7 with the flaw determining threshold voltage Vc, so that the flaw determining threshold voltage Vc can be changed with no time delay and thus high-speed surface inspection can be performed.

The above-described third embodiment is merely an embodiment of the present invention, and thus any modification may be made within the scope of the present invention.

For example, the surface inspecting device 309 is configured so that the detection signal Sk of the sensor head 7 is directly compared with the flaw determining threshold voltage Vc to detect a flaw, however, the present invention is not limited to this style. That is, a brightness image in which the intensity of the detection signal Sk at each scan position Z of the inner surface 3A of the bore 3 is represented by a brightness value may be generated on the basis of the detection signal Sk of the sensor head 7 and the scan position Z, the brightness image may be compared with the brightness threshold value for determining a flaw to detect a flaw, and this brightness threshold value maybe changed in accordance with the intersecting angle γ between the scan direction and the direction of the cutting work traces P at the scan position Z of the sensor head 7.

According to this construction, the size and shape of a flaw can be estimated on the basis of the range of pixels whose brightness values exceed the brightness threshold value.

### DESCRIPTION OF REFERENCE NUMERALS

1, 201, 301 bore inner surface inspecting system
3 bore
3A inner surface
5 cylinder block
7 sensor head
9, 109, 209, 309 surface inspecting device
51, 251, 351 position controller
55 estimation image generator
57 estimator
63 one-dimensional power spectral processor
70 digital brightness image
70A one-dimensional digital brightness image
71 one-dimensional power spectral image
73 estimation image
75 extraction window
78 binarized image
79 polishing residue extracted image
90 workpiece
91 camera
92 working direction determining unit
100 surface inspecting system
226 eddy current inspecting sensor
253 eddy current inspecting unit
255 laser inspecting unit
261 defect detector
267 image processing range determining unit
269 estimator
270 defect map image
271 digital brightness image
353 detector (detecting means)
355 parameter setting unit
359 D/A board (D/A converting means)
360A Z-Vr conversion data
360B Z-Vc conversion data
363 noise compressor
365 threshold value determining unit
379 noise compression filter
385 external noise compression value input unit
389 + side comparator
391 − side comparator
399 external threshold value input unit
3103 grind stone flaw
Cr voltage range
F defect site
G dent
H image processing range
Ja end portion area
Jb intermediate area
P cutting work trace
Sk detection signal
Q polishing residue
Vc flaw determining threshold voltage
Vr compression range voltage
Vref AGC reference voltage
Z scan position

1. A surface inspecting device for inspecting a machined surface of a workpiece on the basis of a digital image of the surface of the workpiece, characterized by comprising:
estimation image generating means that generates one-dimensional power spectral images in a direction perpendicular to a direction of a machining work on the basis of the digital image and arranging the one-dimensional power spectral images in parallel along the direction of the machining work to generate an estimation image; and
estimating means that estimates the surface on the basis of pixel values of respective pixels of the estimation image.

2. A surface inspecting device for inspecting a polished inner surface of a bore formed in a cylinder block by a cutting work on the basis of a digital image of the inner surface of the bore, characterized by comprising:
estimation image generating means that generates one-dimensional power spectral images in a direction perpendicular to a direction of the cutting work on the basis of the digital image and arranging the one-dimensional power spectral images in parallel along the direction of the cutting work to generate an estimation image; and
estimating means that estimates polishing residue on the inner surface of the bore on the basis of pixel values of respective pixels of the estimation image.

3. A surface inspecting device for inspecting a machined surface of a workpiece on the basis of a digital image of the surface of the workpiece, characterized by comprising:
estimation image generating means that generates an image obtained by successively generating and parallel arranging one-dimensional power spectral images along a predetermined direction on the basis of the digital image to generate an image, rotates the predetermined direction with respect to the digital image every predetermined angle to generate the image at each rotational angle, and selects an image containing a largest number of spectral signals as an estimation image from respective images; and
estimating means that estimates the surface on the basis of pixel values of respective pixels of the estimation image selected by the estimation image generating means.

4. The surface inspecting device according to claim 1, wherein pixels having pixel values exceeding a predetermined pixel value in the estimation image are color-coded together with respective pixels of the one-dimensional spectral image containing the pixels.

5. The surface inspecting device according to claim 1, further comprising:
an eddy current inspecting sensor that scans the surface of the workpiece; and
inspecting range determining means that specifies a defect site of the workpiece on the basis of an output of the eddy current inspecting sensor and determines an inspecting range containing the defect site, wherein the surface of the workpiece is scanned by a sensor head for irradiating the surface with a laser beam, a digital image of the surface is generated on the basis of reflection light of the laser beam, and the digital image of the inspection range is subjected to image processing for detecting a defect on the surface.

6. The surface inspecting device according to claim 5, wherein the surface of the workpiece is a polished inner surface of a bore formed in a cylinder block by a cutting work, and image processing range determining means that specifies a defect site on the basis of an output of the eddy current inspecting sensor and determines an image processing range containing the defect site, wherein the image processing range is subjected to the image processing to detect a defect on the inner surface.

7. The surface inspecting device according to claim 5, wherein the sensor head is provided with the eddy current inspecting sensor.

8. The surface inspecting device according to claim 2, further comprising:
a sensor head for scanning the inner surface of the bore of the cylinder block while irradiating the inner surface with light, and outputting a detection signal corresponding to a light amount of reflection light of the light; and
detecting means that detects a flaw on the inner surface on the basis of the detection signal, wherein the detecting means changes a determining threshold value for the detection signal for determining the flaw in accordance with an intersecting angle between a scan direction at a scan position of the sensor head and a direction of the cutting work.

9. The surface inspecting device according to claim 8, wherein the detecting means has noise compressing means that lowers a voltage value of a voltage range corresponding to noise with respect to the detection signal to compress the noise, and the noise compressing means changes the voltage range in accordance with the intersection angle between the scan direction at the scan position of the sensor head and the direction of the cutting work.

10. The surface inspecting device according to claim 8, characterized by comprising:
storage means that stores the determining threshold value corresponding to the intersection angle between the scan direction at the scan position of the sensor head and the direction of the cutting work in association with the scan position; and
D/A conversion means that outputs an analog signal of a voltage value representing the determining threshold value, wherein the detecting means has a comparator for comparing the analog signal output from the D/A conversion means with the detection signal.

11. A surface inspecting device, characterized by comprising:
a sensor head for scanning an inner surface of a bore formed in a cylinder block by a cutting work while irradiating the inner surface with light, and outputting a detection signal corresponding to a light amount of reflection light of the light; and
detecting means that detects a flaw on the inner surface on the basis of the detection signal, wherein the detecting means changes a determining threshold value for the detection signal for determining the flaw in accordance with an intersecting angle between a scan direction at a scan position of the sensor head and a direction of the cutting work.

12. The surface inspecting device according to claim 11, wherein the detecting means has noise compression means for lowering a voltage value of a voltage range corresponding to noise to subject the detection signal to noise compression, and the noise compression means changes the voltage range in accordance with an intersection angle between the scan direction and the cutting work direction at the scan position of the sensor head.

13. The surface inspecting device according to claim 11, further comprising:
storage means that stores the determining threshold value corresponding to the intersection angle between the scan direction at the scan position of the sensor head and the direction of the cutting work in association with the scan position; and
D/A conversion means that outputs an analog signal of a voltage value representing the determining threshold value, wherein the detecting means has a comparator for comparing the analog signal output from the D/A conversion means with the detection signal.

14. The surface inspecting device according to claim 2, wherein pixels having pixel values exceeding a predetermined pixel value in the estimation image are color-coded together with respective pixels of the one-dimensional spectral image containing the pixels.

15. The surface inspecting device according to claim 3, wherein pixels having pixel values exceeding a predetermined pixel value in the estimation image are color-coded together with respective pixels of the one-dimensional spectral image containing the pixels.

16. The surface inspecting device according to claim 9, characterized by comprising:
storage means that stores the determining threshold value corresponding to the intersection angle between the scan direction at the scan position of the sensor head and the direction of the cutting work in association with the scan position; and
D/A conversion means that outputs an analog signal of a voltage value representing the determining threshold value, wherein the detecting means has a comparator for comparing the analog signal output from the D/A conversion means with the detection signal.

17. The surface inspecting device according to claim 12, further comprising:
storage means that stores the determining threshold value corresponding to the intersection angle between the scan direction at the scan position of the sensor head and the direction of the cutting work in association with the scan position; and
D/A conversion means that outputs an analog signal of a voltage value representing the determining threshold value, wherein the detecting means has a comparator for comparing the analog signal output from the D/A conversion means with the detection signal.
